(19) United States
(12) Patent Application Publication
(10) Pub. No.: US 2014/0122094 A1
(43) Pub. Date: May 1, 2014

(54) INTRAVENOUS FLUID AND MEDICATION ADMINISTRATION SYSTEM

(71) Applicants: Mason Arthur Smith, Bellevue, WA (US); Sergey A. Baranovsky, Woodinville, WA (US)

(72) Inventors: Mason Arthur Smith, Bellevue, WA (US); Sergey A. Baranovsky, Woodinville, WA (US)

(21) Appl. No.: 13/662,839

(22) Filed: Oct. 29, 2012

(51) Int. Cl. G06Q 50/22; G06Q 20/14

(52) U.S. Cl. 705/2

(57) ABSTRACT

Systems and methods for determining billing codes and numbers of billing units for time-based medical services. Each medical service is associated with a service type, a start time, and an end time. Embodiments identify medical services associated with the same service type that overlapped and modifying the start time and/or the end time of at least one of the overlapping medical services so that they no longer overlap. A hierarchy is used to rank the service types. Medical services that overlapped and have different service types are identified and overlapping time is subtracted from the duration of a lower ranked one of the medical services. One or more of the medical services are identified as being billable based on a set of billing rules, and a billing code and a number of billable units are identified for each of the billable medical services.

### BACKGROUND OF THE INVENTION

1. Field of the Invention

The present invention is directed generally to methods and systems for determining billing codes and numbers of billable units for medical services.

2. Description of the Related Art

A patient's healthcare related expenses are often paid by a third party, such as a medical insurance company or governmental entity (e.g., Medicaid, or Medicare). To receive compensation, a healthcare provider (e.g., a hospital, physician, and the like) may be required to present a billing code that identifies the service provided, and a number of billable units of the service provided. For example, a set of billing codes used for this purpose is included in a Current Procedural Terminology Manual 2012 (referred to herein as the “CPT”) published by the American Medical Association. Information published in the CPT is supplemented by additional guidance provided by the Medicare program, medical insurance companies, and the like.

For some medical services, the number of billable units of the service provided is determined based on a duration over which the medical service was provided. For example, Medicare and other entities that pay for hospital outpatient services require that healthcare providers report the duration of services that fall within a special category of services known as time-based medical services (which include intravenous (“IV”) infusions of pharmaceuticals, hydration, nutrition, and the like). Payment for these services is contingent on the duration of the service. To comply with the CPT and Medicare billing instructions, healthcare providers must determine the duration of every time-based medical service for which they bill. By way of examples, the duration may be required for critical care services, observation services, intravenous fluid administration services, and medication administration services.

The durations of time-based medical services are typically determined by office staff (referred to herein as “coders”) employed by the healthcare provider. Conventionally, the durations of the time-based medical services have been either calculated manually by coders, or not coded due to lack of knowledge regarding the complex rules. These manual methods require that coders convert start and end times for a service into a total duration measured in minutes. Unfortunately, coders frequently make errors when subtracting end times from start times to calculate the duration in minutes.

To further complicate the calculation, a unit of time may be billed only once, even if multiple time-based medical services overlapped (i.e., were provided concurrently at least in part). Thus, to bill for overlapping services, a “primary” service must be identified for each overlapping period. For each overlapping period, the healthcare provider may bill for only the primary service. To calculate the duration of the services other than the one or more primary services, the healthcare provider must exclude time spent delivering overlapping services. Thus, after determining the overlap period, the coder must adjust the duration of each non-primary service to eliminate concurrent billing of time-based services.

A hierarchy of services is used to identify which service is primary. The CPT includes the following ranking (with one being the highest ranked service and three being the lowest ranked service):

1. IV medication infusion services (“infusions”);

2. IV medication pushes (“pushes”); and

3. IV hydration services (“hydration”).

Thus, for each service provided, the coder must know whether the service is an infusion, a push, or hydration. Then, the coder must adjust the duration of each non-primary service by eliminating any time during which the non-primary service overlapped with the primary service. For example, if a (non-primary) hydration service overlaps with a (primary) IV medication infusion service, the duration of the hydration service is adjusted to eliminate the minutes of overlap with the IV medication infusion service. The duration of the IV medication infusion service remains unchanged. If two or more IV infusion services overlap with one another any one of them may be selected as the primary service.

Next, the coder must determine a number of billable units for the service. For example, if the adjusted duration of the IV medication infusion service exceeds 90 minutes, the coder must calculate the number of additional billable units (e.g., hours), if any. Additional units are referred to as “add on” time. The CPT includes detailed rules regarding how billable units are determined. For example, if IV medication infusion services overlap with other IV medication infusion services, the non-overlapping duration may fail to qualify for billing as an infusion. In the case where the IV infusion duration is adjusted to 15 minutes or less, the service is billed as an IV push rather than an IV infusion. The CPT includes minimum duration requirements for some time-based medical services. If the adjusted duration of the service is less than the minimum duration specified in the CPT, the healthcare provider cannot bill for the service. The CPT also includes rules related to minimum intervals between pushes of the same medication that must be satisfied.

Conventional methods of billing for time-based medical services require several error prone manual determinations by coders. First, the coder must identify the correct billing code using a set of billing codes (e.g., the codes provided by the CPT). Second, the coder must determine a type (e.g., infusion, push, or hydration) for each time-based medical service. Third, the coder must correctly identify the primary service for each period during which two or more services of different types were provided simultaneously using a hierarchy that ranks types of services. Fourth, the coder must correctly calculate the duration (in minutes) of each service. Fifth, if two or more services overlap, the coder must calculate an adjusted duration for at least one of the two or more overlapping services. Finally, the coder must apply additional rules to determine for how may units (if any) to bill based on the adjusted duration. With so many detailed determinations to make, coders frequently make errors.

These errors create significant problems for healthcare providers because invoices generated by healthcare providers are subjected to a validation process performed by governmental and third party insurance entities. Significant fines can be levied by the government for billing violations. For example, applicable U.S. laws provide a maximum fine of $15,000 per billing error if the error is found to be intentional or negligent on the part of the billing entity. Under these serious circumstances, accuracy is critical and an audit trail is required for any automated solution for billing time-based medical services.

Thus, a need exists for systems and methods that receive patient treatment information and automatically determine a billing code and a number of billable units for each time-based medical service identified in the patient treatment information. The present application provides these and other advantages as will be apparent from the following detailed description and accompanying figures.

### BRIEF DESCRIPTION OF THE SEVERAL VIEWS OF THE DRAWING(S)

FIG. 1A is a diagram of a first embodiment of a system configured to receive patient treatment information, and determine a billing code and number of billable units for each time-based medical service identified in the patient treatment information.

FIG. 1B is a diagram of a second embodiment of a system configured to receive patient treatment information, and determine a billing code and number of billable units for each time-based medical service identified in the patient treatment information.

FIG. 2A is flow diagram of a method performed by a client computing device of the system of FIG. 1A.

FIG. 2B is flow diagram of a method performed by at least one of the computing devices of a host portion of the system of FIG. 1A.

FIG. 2C is flow diagram of a method performed by at least one of the computing devices of a host portion of the system of FIG. 1B.

FIG. 3A is an illustration of a data entry screen displayable to an end user by the client computing device of the system of FIG. 1A.

FIG. 3B is an illustration of a dialog box displayable to the end user by the client computing device of the system of FIG. 1A.

FIG. 4 is an illustration of the data entry screen of FIG. 3A populated with different patient treatment information.

FIG. 5 is an illustration of a user interface summary screen displayable to an end user by the client computing device of the system of FIG. 1A.

FIG. 6 is flow diagram of a method of determining a billing code and number of billable units for each time-based medical service identified in the patient treatment information.

FIG. 7A is pseudo source code for an exemplary function PROCESS_OVERLAPPING_INFUSIONS( ) that calculates the durations of IV medication infusion services, including those that overlap, and modifies the start time and/or end time of at least one of two or more overlapping services so that they no longer overlap.

FIG. 7B is pseudo source code for an exemplary function PROCESS_OVERLAPPING_HYDRATIONS( ) that adjusts the start time and/or end time of at least one of two or more overlapping hydration services so that they no longer overlap.

FIG. 7C is pseudo source code for an exemplary function INFUSION_OVERLAPPING([IV Hydration]) that adjusts the duration of a hydration service received as an input parameter if the hydration service overlaps with one or more infusion services.

FIG. 8A is flow diagram of a first portion of a method that calculates the durations of IV medication infusion services, including those that overlap, and modifies the start time and/or end time of at least one of two or more overlapping infusions so that they no longer overlap.

FIG. 8B is flow diagram of a second portion of the method of FIG. 8A.

FIG. 9 is flow diagram of a method that adjusts the start time and/or end time of at least one of two or more overlapping hydration services so that they no longer overlap.

FIG. 10 is flow diagram of a method that adjusts the duration of a hydration service received as an input parameter if the hydration service overlaps with one or more infusion services.

FIG. 11 is an exemplary listing of results generated by the method of FIG. 6 that may be used as an audit trail.

FIG. 12 is a diagram of a hardware environment and an operating environment in which each of the computing devices of the systems of FIGS. 1A and 1B may be implemented.

### DETAILED DESCRIPTION OF THE INVENTION

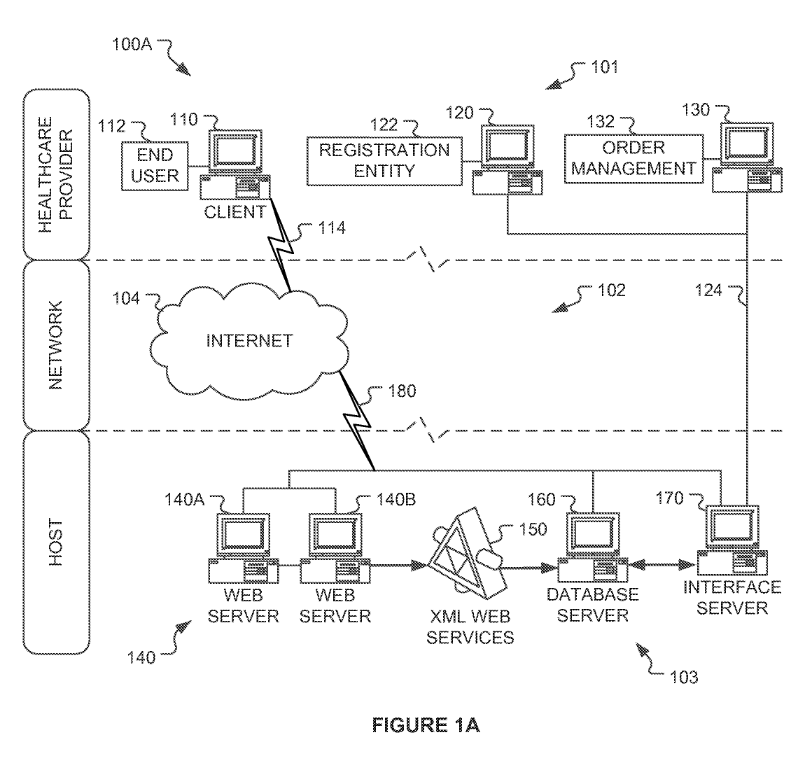

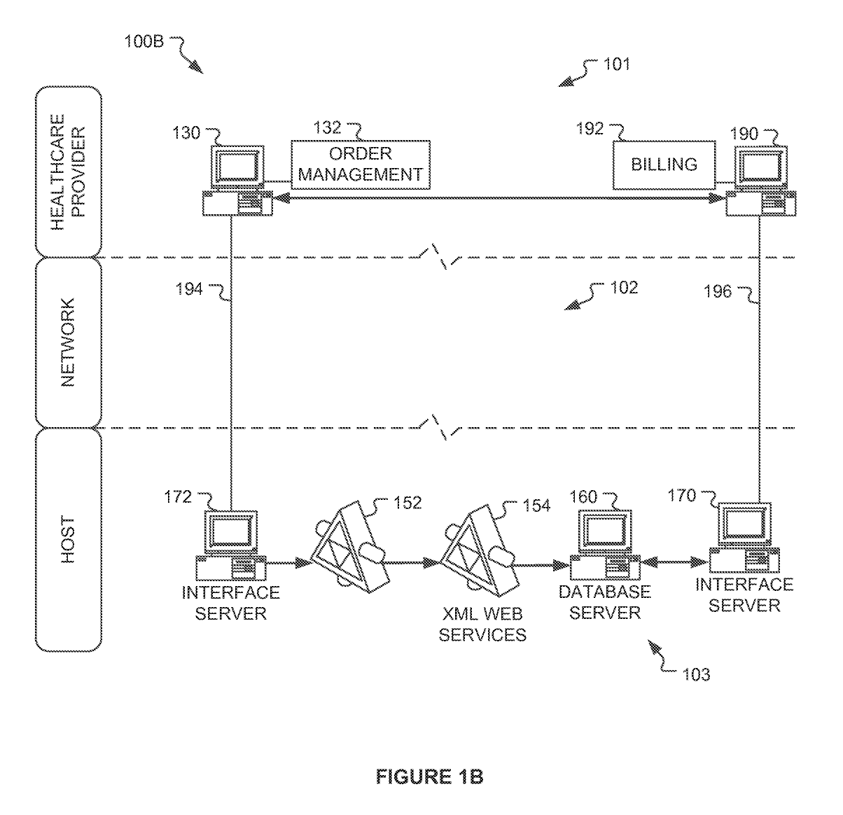

As explained in the Background Section, to obtain compensation for time-based medical services from a third party (such as an insurance company or governmental entity), healthcare providers typically need to provide a billing code and a number of billable units for each time-based medical service for which the healthcare provider is seeking compensation. FIG. 1A is a schematic illustrating a first embodiment of a system 100A configured to determine billing codes and numbers of billable units for time-based medical services. FIG. 1B is a schematic illustrating a second embodiment of a system 100B configured to determine billing codes and numbers of billable units for time-based medical services. Like reference numerals have been used to identify like components of the systems 100A and 100B. As mentioned above, time-based medical services may include critical care services, observation services, intravenous fluid administration services, and medication administration services. The systems 100A and 100B are not limited to use with respect to particular types of time-based medical services.

The systems 100A and 100B will be described as determining billing codes and numbers of billable units for time-based medical services for an encounter with a patient. An encounter includes a time during which time-based medical services were provided to the patient by the healthcare provider. By way of a non-limiting example, an encounter may include an emergency department visit, a chemotherapy session, an outpatient clinic visit, and the like. The systems 100A and 100B are not limited to use with respect to a particular type of encounter.

To identify the correct billing code and number of billable units, the following information is needed for each time-based medical service provided during an encounter:

1. Type of service (e.g., infusion, push, or hydration);

2. Start time; and

3. End time.

Optionally, the types of service may include chemotherapy infusions and chemotherapy pushes. The start and end times include date information. Thus, the systems 100A and 100B may be used to determine billing codes and numbers of billable units for time-based medical services that extend over multiple days or occur on different days.

By way of a non-limiting example, in the first embodiment illustrated in FIG. 1A, the system 100A may be implemented as a web based application that may be a component of a standalone website-based service. The system 100A may be characterized as including a healthcare provider portion 101, a communication or network portion 102, and a host portion 103.

In the embodiment illustrated, the network portion 102 includes the Internet 104. However, this is not a requirement.

The healthcare provider portion 101 is operated by a healthcare provider and may include software external to the system 100A. Such external software may include invoicing software, patient record generation and storage software, healthcare management software, and the like. The healthcare provider portion 101 communicates with the host portion 103 over the network portion 102.

The healthcare provider portion 101 includes a client computing device 110 operated by an end user 112 (e.g., a nurse). The client computing device 110 may implement a web browser application configured to receive and display web pages and other content received over the network portion 102 to the end user 112. The client computing device 110 is used to input patient treatment information, and optionally, to display billing codes and numbers of billable units determined for each time-based medical service identified in the patient treatment information. The client computing device 110 is connected to the network portion 102 via a communication link 114. In the embodiment illustrated, the communication link 114 has been implemented as a wireless communication link. However, other types of communication links, including a wired communication link may be used. The communication link 114 may be implemented at least in part as a Hypertext Transfer Protocol Secure (“HTTPS”) connection using a secure socket layer (“SSL”). While FIG. 1A illustrates the single client computing device 110, a plurality of client computing devices like the client computing device 110 each configured to provide the functionality of the client computing device 110 may be connected to the host portion 103 via the network portion 102.

The healthcare provider portion 101 includes a registration computing device 120 operated by a registration entity 122 (e.g., a hospital registration entity). The registration computing device 120 collects and stores patient registration data. For example, the registration computing device 120 may be connected to a storage device (not shown) that stores a central data file (not shown), which includes patient registration data. The registration computing device 120 stores patient data in the central data file and accesses the patient data stored in the central data file. In the embodiment illustrated, the registration computing device 120 is connected to the network portion 102 via a communication link 124. In the embodiment illustrated, the communication link 124 has been implemented as a wired communication link. However, other types of communication links, including a wireless communication link may be used. The communication link 124 may be implemented at least in part as a secure virtual private network (“VPN”) channel. While the system 100A depicted in FIG. 1A includes the single registration computing device 120, the healthcare provider portion 101 may include a plurality of computing devices like the registration computing device 120 configured to provide (separately or together) the functionality of the registration computing device 120.

The healthcare provider portion 101 includes an OM computing device 130 operated by an order management entity 132 (e.g., a hospital order management entity). The OM computing device 130 receives the billing codes, numbers of billable units, and/or amounts to charge determined by the host portion 103. The OM computing device 130 may use this information to generate invoices for services provided to patients. In some embodiments, the OM computing device 130 is connected to a billing computing device (e.g., a billing computing device 190 illustrated in FIG. 1B) that generates invoices for a third party (e.g., an insurance company, governmental entity, and the like). In the embodiment illustrated, the OM computing device 130 is connected to the network portion 102 via the communication link 124. However, a different communication link may be used. While FIG. 1A illustrates the single OM computing device 130, the healthcare provider portion 101 may include a plurality of computing devices like the OM computing device 130 configured to provide (separately or together) the functionality of the OM computing device 130.

The host portion 103 may be operated by a third party host that is different from the healthcare provider. However, this is not a requirement. The host portion 103 includes a cluster of web server computing devices 140 configured to host a website and serve web pages to the web browser implemented by the client computing device 110 via the network 103. The cluster of web server computing devices 140 also receives patient treatment information input by the end user 112. While in FIG. 1A the cluster of web server computing devices 140 includes two web server computing devices 140A and 140B, any number of computing devices like the web server computing devices 140A and 140B may be included in the cluster of web server computing devices 140.

The host portion 103 includes a WS computing device 150 configured to provide web services (e.g., XML web services) to the cluster of web server computing devices 140. The cluster of web server computing devices 140 forwards patient treatment information to the WS computing device 150. The WS computing device 150 forwards patient treatment information to a database server computing device 160. While FIG. 1A illustrates the single WS computing device 150, the host portion 103 may include a plurality of computing devices like the WS computing device 150 configured to provide (separately or together) the functionality of the WS computing device 150.

The database server computing device 160 is configured to store information needed to determine the billing codes and numbers of billable units. The database server computing device 160 may also store the billing codes and billable units determined for each time-based medical service. By way of a non-limiting example, the database server computing device 160 may be implemented using SQL2000. While in FIG. 1A only the single database server computing device 160 has been illustrated, the host portion 103 may include any number of computing devices like the database server computing device 160 configured to provide (separately or together) the functionality of the database server computing device 160.

The host portion 103 includes an interface server computing device 170 configured to generate an interface for the registration and OM computing devices 120 and 130. The interface server computing device 170 is configured to access the database server computing device 160 and communicates information stored in the database server computing device 160 to the registration and OM computing devices 120 and 130. For example, the interface server computing device 170 may obtain the billing codes and numbers of billable units from the database server computing device 160 and communicate them to the OM computing device 130. The interface server computing device 170 may be configured to communicate in accordance with a Health Level Seven International (“HL7”) standard. While in FIG. 1A only the single interface server computing device 170 has been illustrated, the host portion 103 may include any number of computing devices like the interface server computing device 170 configured to provide (separately or together) the functionality of the interface server computing device 170.

In the embodiment illustrated, the cluster of web server computing devices 140, the database server computing device 160, and the interface server computing device 170 are connected to the network portion 102 via a communication link 180. In the embodiment illustrated, the communication link 180 has been implemented as a wireless communication link. However, other types of communication links, including a wired communication link may be used.

The communication link 180 may be implemented at least in part as a secure HTTPS connection using a SSL.

The communication link 124 extends between the OM computing device 130 and the interface server computing device 170. Thus, IV services coding data may be routed from the interface server computing device 170 to the OM computing device 130 via a secure Internet connection.

In the system 100A, patient treatment information may be received from the registration computing device 120 (e.g., part of a hospital patient registration system) and used by the database server computing devices 160 (e.g., individual hospital database on a cloud server) to create a patient encounter record. IV services data is received from the client computing devices 110. Business logic is applied by the host portion 103 (e.g., by one or more of the computing devices 140A, 140B, 150, 160, and 170) of the system 100A and results (billing codes and numbers of billable units) are routed back to the client computing device 110 for display thereby to the end user 112. The results may also be routed to the OM computing device 130 and used to bill a third party (e.g., an insurance company, governmental entity, and the like).

Turning to FIG. 1B, the system 100B includes the healthcare provider portion 101, the network portion 102, and the host portion 103. In this embodiment, the client computing device 110 may be omitted from the healthcare provider portion 101. Instead, the OM computing device 130 may communicate patient treatment information to the host portion 103. Thus, the software executing on the host portion 103 may be characterized as a module linked to an electronic medical record stored by the healthcare provider portion 101 and provided to the module by one or more external software applications executing on the OM computing device 130.

The healthcare provider portion 101 of the system 100B includes the billing computing device 190 operated by a billing entity 192. The billing computing device 190 is connected to the OM computing device 130 and communicates therewith. For example, the OM computing device 130 may communicate billing codes and numbers of billable units to the billing computing device 190. While the system 100B depicted in FIG. 1B includes the single billing computing device 190, the healthcare provider portion 101 may include a plurality of computing devices like the billing computing device 190 configured to provide (separately or together) the functionality of the billing computing device 190.

While not illustrated in FIG. 1B, the healthcare provider portion 101 of the system 100B may include the registration computing device 120 (see FIG. 1A).

While not a requirement, the network portion 102 may include the Internet 104 (see FIG. 1A).

In the system 100B, the host portion 103 includes a first interface server computing device 172 configured to communicate with the one or more external software applications executing on the OM computing device 130. For example, the one or more external software applications executing on the OM computing device 130 may communicate laboratory results to the first interface server computing device 172. The first interface server computing device 172 may be configured to communicate in accordance with a Health Level Seven International (“HL7”) standard.

The cluster of web server computing devices 140 may be omitted from the host portion 103 of the system 100B and the interface server computing device 170 referred to as a second interface server computing device.

As mentioned above, the WS computing device 150 of the system 100A may be implemented using multiple computing devices. In the system 100B, the host portion 103 includes a first WS computing device 152 and a second WS computing device 154. The first WS computing device 152 may be configured to implement a rules engine (e.g., a Domain Specific Language (“DSL”) rules engine) and/or data point mapping. The second WS computing device 154 may be configured to implement automatic calculation.

The first interface server computing device 172 is connected to the OM computing device 130 across the network portion 102 by a communication link 194. In the embodiment illustrated, the communication link 194 has been implemented as a wired communication link. However, other types of communication links, including a wireless communication link may be used. The communication link 194 may be implemented at least in part as a secure VPN channel. While the system 100B depicted in FIG. 1B includes the single first interface server computing device 172, the host portion 103 may include a plurality of computing devices like the first interface server computing device 172 configured to provide (separately or together) the functionality of the first interface server computing device 172.

The second interface server computing device 170 is connected to the billing computing device 190 across the network portion 102 by a communication link 196. In the embodiment illustrated, the communication link 196 has been implemented as a wired communication link. However, other types of communication links, including a wireless communication link may be used. The communication link 196 may be implemented at least in part as a secure VPN channel. The second interface server computing device 170 may communicate the billing codes, numbers of billable units, and/or amounts to charge to the billing computing device 190 across the communication link 196.

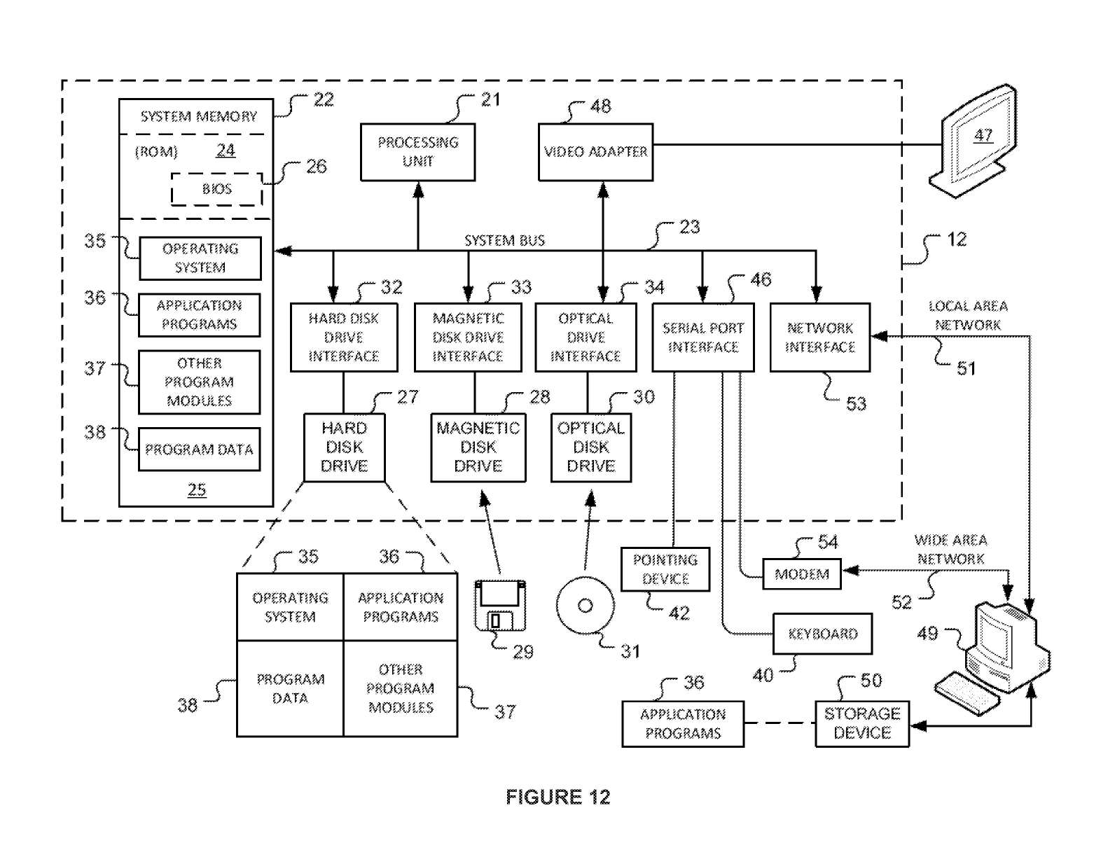

An exemplary hardware environment and an exemplary operating environment in which each of the computing devices 110, 120, 130, 140A, 140B, 150, 152, 154, 160, 170, 172, and 190 of the systems 100A and 100B may be implemented is described below with respect to FIG. 12.

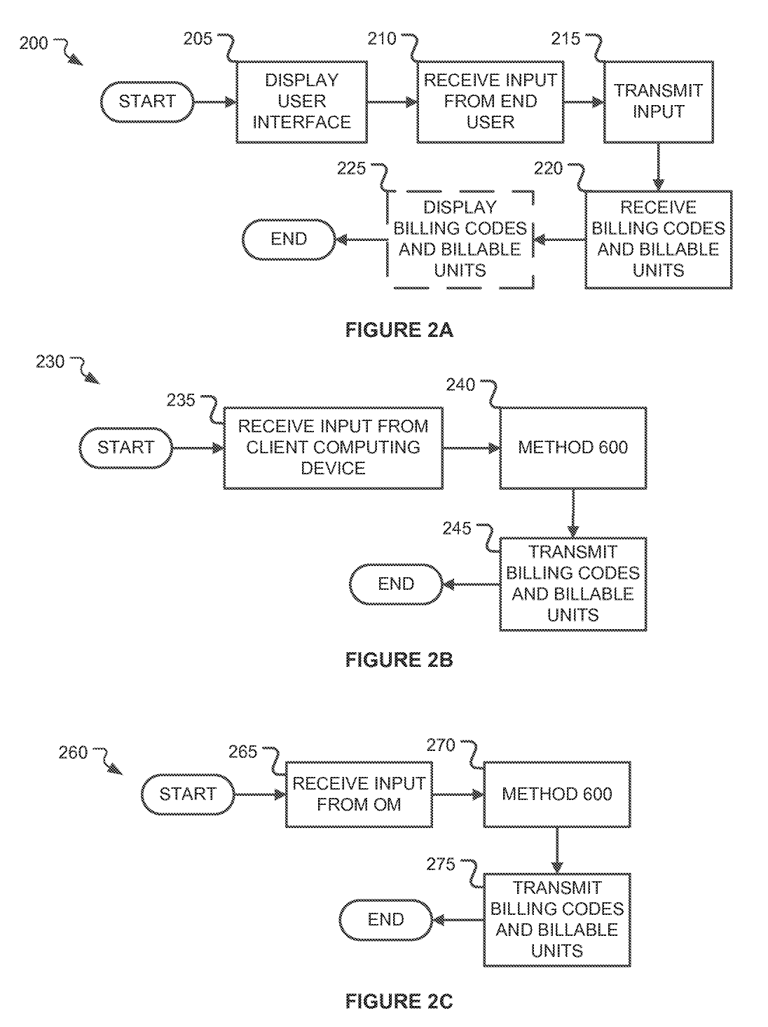

As mentioned above, in the system 100A illustrated in FIG. 1A, the host portion 103 receives input from the end user 112 via the client computing device 110. FIG. 2A is a flow diagram of a method 200 performed by the client computing device 110 of the system 100A. In first block 205, the client computing device 110 displays a user interface to the end user 112. The client computing device 110 may receive at least a portion of the user interface (e.g., web pages) from the cluster of web server computing devices 140.

In block 210, the client computing device 110 receives input from the end user 112 via the user interface displayed in block 205. The end user 112 may enter patient treatment information into the user interface that is used by the host portion 103 to determine billing codes and numbers of billable units. For each time-based medical service, the input includes type of service, start time, and end time.

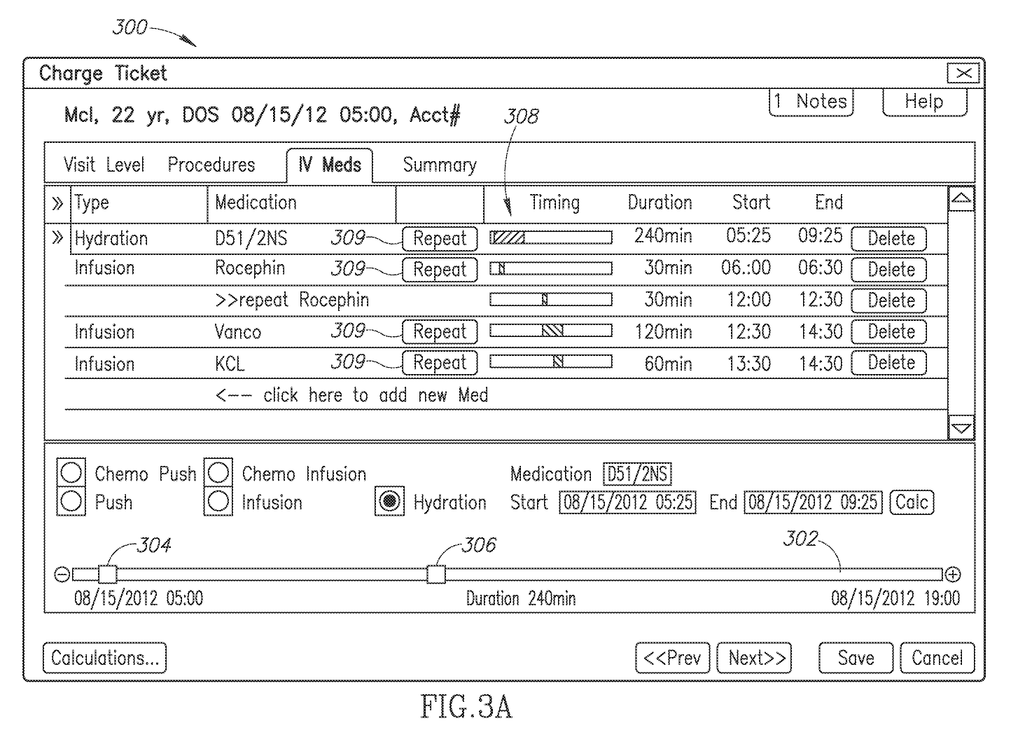

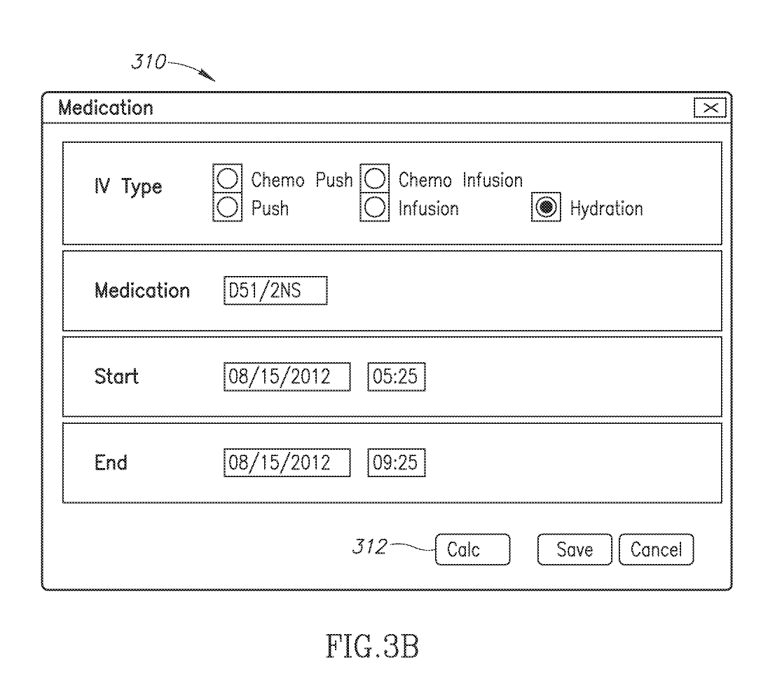

FIG. 3A is an exemplary data entry screen 300 that may be displayed in block 205 and used by the end user 112 in block 210 to enter information about the time-based medical services provided during the encounter.

FIG. 3B is an exemplary dialog box 310 that may be used to enter data (e.g., start time and end time) via a keyboard (e.g., a keyboard 40 illustrated in FIG. 12) for a particular time-based medical service. In the implementation discussed with respect to FIGS. 3A and 3B, the system 100A is supplied input data directly by the end user 112. The data entry screen 300 and the dialog box 310 both receive as input the type of service, the start time, and the end time. The data entry screen 300 includes a time line 302 and sliders 304 and 306, which may be moved (slid) to indicate start time and end time, respectively. As is apparent to those of ordinary skill in the art, the start time, and the end time each include both date and time components. In implementations where the end user 112 is a nurse or other skilled healthcare professional, the type of service would be known to the end user. Such implementations improve upon the conventional method which use coders (who are support staff) to identify the type of service.

For each time-based medical service, the data entry screen 300 displays its start time and end time. The data entry screen 300 includes a visual display 308 (horizontal bars) illustrating a sequence in which the services are entered. The order in which the time-based medical services have been entered does not affect the services, the billing codes, or the number of billable units determined by the systems 100A and 100B as having been provided and reported as appropriate to bill. The visual display 308 also displays graphically the durations (by the lengths of the bars) of the services and whether the services overlap (occur at least in part at the same time). The data entry screen 300 may display a calculated duration (ignoring overlapping time) for each service in minutes.

Referring to FIG. 3A, the data entry screen 300 may be configured to assure that repeat administration of the same medication is billed correctly. According to the CPT, a second administration (repeat) of an IV infusion of the same medication is not reported as a sequential new drug but is instead reported using an “add-on” code in the amount of one billable unit. Next to each infusion, the data entry screen 300 may include a “repeat” button 309. The end user 112 may use the “repeat” button 309 to indicate that an IV infusion service is a repeat administration of a previously administered medication. In situations where IV services data is provided directly from a hospital electronic medical record, the “repeat” feature may be triggered by the identification of the same drug identification number more than once in a medication field (not shown) for a single encounter with a patient. For a repeat infusion, the host portion 102 will report the correct billing codes and calculate the duration of the service to determine if “add on” hours are appropriate to bill.

Referring to FIG. 3B, the dialog box 310 includes a “Calc” button 312 that brings up a calculator tool (not shown) that may be used to calculate an estimated end time when the end time is not included in the record. The calculator tool (not shown) calculates the estimated end time as a function of the start time, volume infused, and rate of infusion.

Returning to FIG. 3A, the data entry screen 300 is illustrated populated with exemplary data for multiple IV infusion services provided during an emergency department visit. These services include the administration of multiple medications and IV fluids for hydration. Specifically, the services listed in Table 1 (below) were provided:

TABLE 1

| Type | Medication | Duration | Start | End |
|---|---|---|---|---|
| Hydration | D51/2NS | 240 min. | 5:25 | 9:25 |
| Infusion | Rocephin | 30 min. | 6:00 | 6:30 |
| Infusion (Repeat) | Rocephin | 30 min. | 12:00 | 12:30 |
| Infusion | Vanco | 120 min. | 12:30 | 14:30 |
| Infusion | KCL | 60 min. | 13:30 | 14:30 |

The data in FIG. 3A and Table 1 has not yet been adjusted for overlapping services. The services can be entered and/or displayed in any order. The end user 112 can enter the last service performed as the first entry or in any other order without effecting the final calculations and codes assigned.

Returning to FIG. 2A, in block 215, the client computing device 110 transmits the input received in block 210 to the host portion 103 (see FIG. 1A). In the embodiment illustrated, the client computing device 110 transmits the input to the cluster of web server computing devices 140 via the network portion 102.

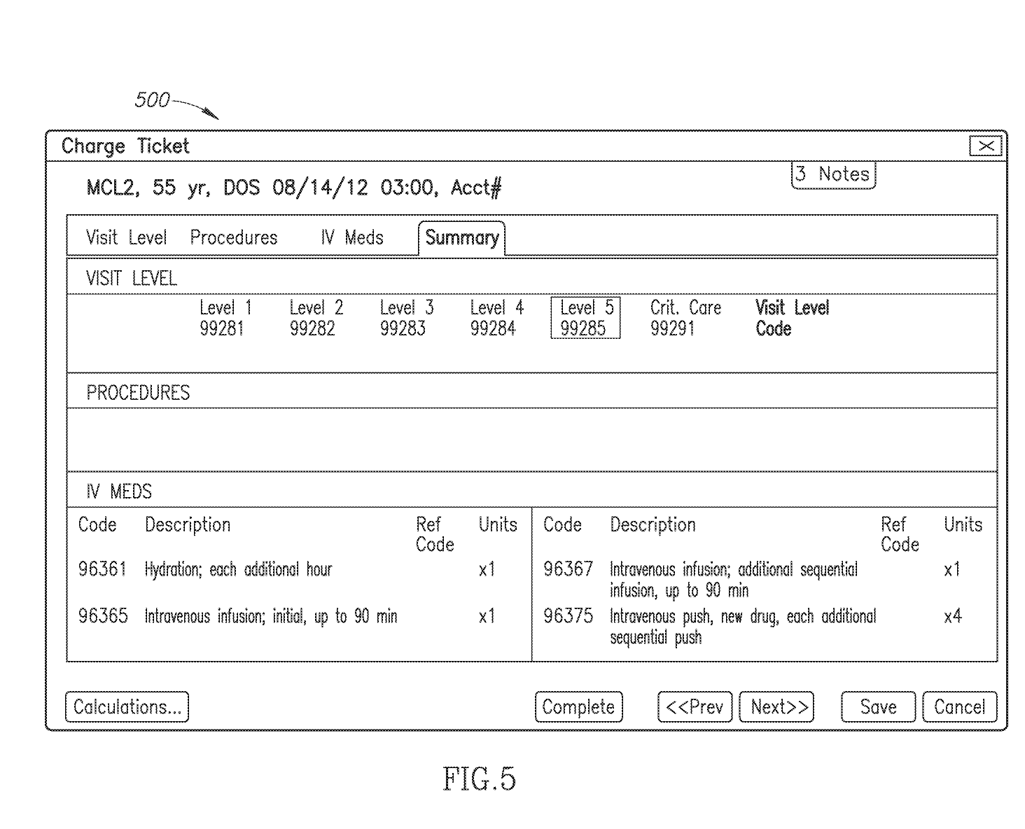

In block 220, the client computing device 110 receives the billing codes and numbers of billable units for the input transmitted to the host portion 103 in block 215. Then, in optional block 225, the client computing device 110 displays the billing codes and numbers of billable units to the end user 112. FIG. 5 is an illustration of a user interface summary screen 500 that may be used to display the billing codes and numbers of billable units to the end user 112. Then, the method 200 terminates.

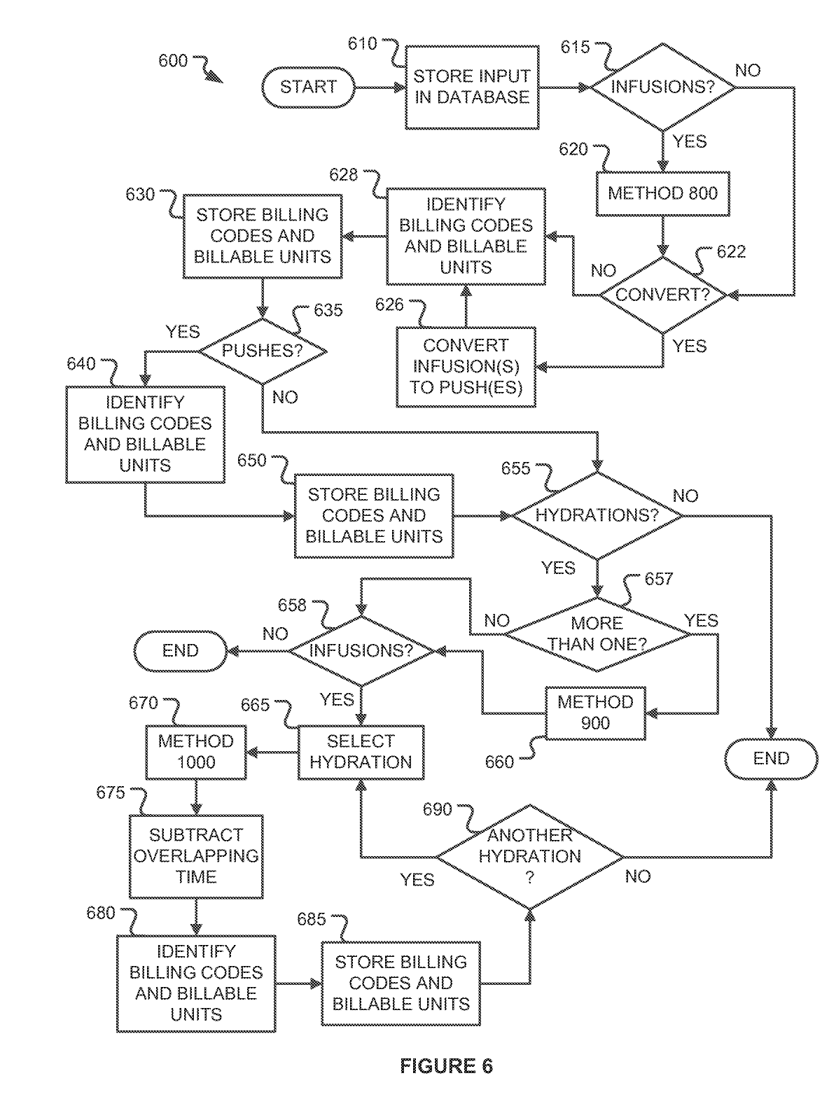

FIG. 2B is a flow diagram of a method 230 performed by the host portion 103 of the system 100A. In first block 235, the cluster of web server computing devices 140 receives the input transmitted by the client computing device 110 in block 215 of the method 200 illustrated in FIG. 2A. The cluster of web server computing devices 140 forwards the input to the WS computing device 150, which forwards the input to the database server computing device 160 for storage thereby. In block 240, at least one of the computing devices of the host portion 103 of the system 100A performs a method 600 (see FIG. 6) that determines the billing codes and numbers of billable units for the input received in block 235. By way of a non-limiting example, the WS computing device 150 may perform at least a portion of the method 600. In block 245, the host portion 103 transmits the billing codes and numbers of billable units to the healthcare provider portion 101 over the network portion 102. For example, in block 245, the cluster of web server computing devices 140 may transmit the billing codes and numbers of billable units to the client computing device 110 from which input was received in block 235. In block 245, the interface computing device 170 may transmit the billing codes and numbers of billable units to the OM computing devices 130. Then, the method 230 terminates.

FIG. 2C is a flow diagram of a method 260 performed by the system 100B illustrated in FIG. 1B. In this embodiment, one or more external software applications executing on the healthcare provider portion 101 may communicate with or use a software module executing on the host portion 103 to perform calculations and determine appropriate billing codes and numbers of billable units. When utilized by one or more external software applications, the system 100B may omit the user interface generated for the end user 112. In its place, the external software application(s) executing on the healthcare provider portion 101 may substitute a different user interface, if desired.

Turning to FIG. 2C, in first block 265, the first interface computing device 172 receives input from an external software application executing on the OM computing device 130. In block 270, at least one of the computing devices of the host portion 103 of the system 100B performs the method 600 (see FIG. 6) that determines the billing codes and numbers of billable units for the input received in block 265. By way of a non-limiting example, the first and second WS computing devices 152 and 154 may perform at least a portion of the method 600. In block 275, the host portion 103 transmits the billing codes and numbers of billable units to the healthcare provider portion 101 over the network portion 102. For example, in block 275, the second interface computing device 170 may transmit the billing codes and numbers of billable units to the billing computing device 190. Then, the method 260 terminates.

### Method 600

Turning to FIG. 6, the method 600 is performed by one or more of the computing devices of the host portion 103 of the system 100A or the system 100B. In the determination of the billing codes, the CPT requires a specific hierarchy of services to identify the “primary service” for an encounter. There can be only one primary service per encounter. As mentioned above, an exemplary hierarchy orders services from highest to lowest as follows: 1) IV medication infusion services; 2) IV medication pushes; and 3) IV hydration services. Each of these categories of services has a primary service type and a subsequent service type.

Optionally, the types of services may include chemotherapy infusions and chemotherapy pushes. In such implementations, in the method 600, chemotherapy infusion services and IV medication infusion services may both be treated as infusions. Optionally, chemotherapy infusion services may be given a higher priority (or rank) than IV medication infusion services. However, in some implementations, additional rules may control how chemotherapy infusions are billed. If the types of services include chemotherapy pushes, in the method 600, chemotherapy pushes and IV medication pushes may both be treated as pushes. Optionally, chemotherapy pushes may be given a higher priority (or rank) than IV medication pushes. However, in some implementations, additional rules may control how chemotherapy pushes are billed.

The method 600 first processes a highest value category of service provided during the encounter, which designates that service type as primary. All other services are categorized as secondary services and reported as subsequent services with the appropriate billing codes. Subsequent services may or may not be time-based services.

If the primary service is a time-based medical service (e.g., an IV medication infusionof, a push, or a hydration service), the primary service may have both a primary billing code and a subsequent service code based on the duration of the service. All other services provided during the same encounter must be reported with subsequent service codes.

The method 600 determines the primary IV service based on the hierarchy of service types as defined in the CPT. The CPT established the hierarchy of primary services in the sequence as follows: Chemotherapy infusion, Chemotherapy IV push, IV infusion, IV push, and Hydration alone. When multiple IV services are provided during a single encounter, only one of the five service types can be assigned as a primary service codes. The method 600 identifies the primary service and establishes that all other IV services, timed or not, will be reported with subsequent or add-on service codes.

In first block 610, the input received by the host portion 103 is stored in the database computing device 160. In decision block 615, whether the input included multiple infusions is determined. The decision in decision block 615 is “YES” when the input included two or more infusions. On the other hand, the decision in decision block 615 is “NO” when the input included only one infusion or no infusions.

When the decision in decision block 615 is “NO,” the host portion 103 advances to decision block 622.

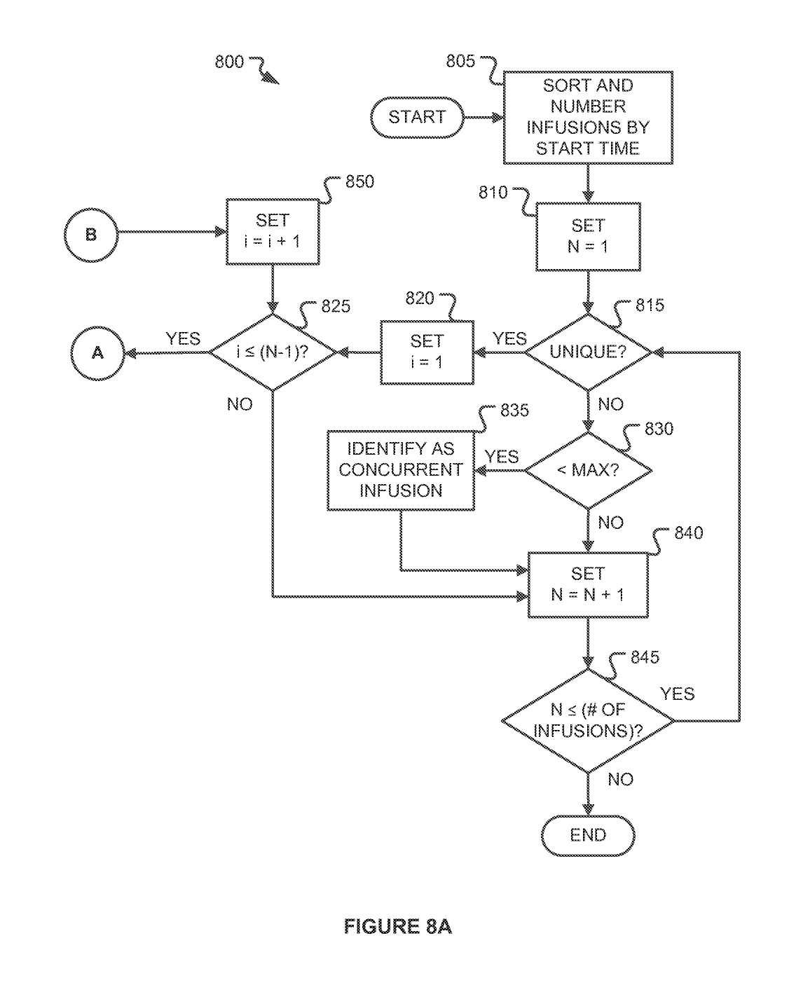

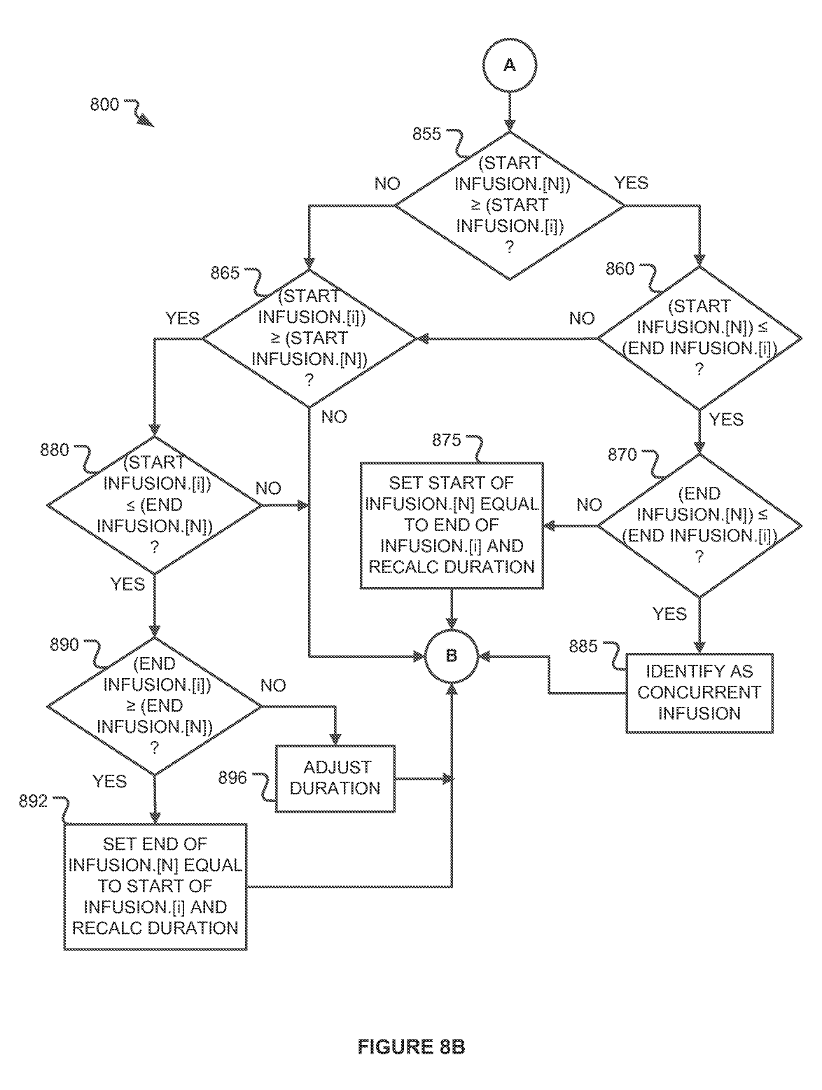

When the decision in decision block 615 is “YES,” in block 620, a method 800 (see FIGS. 8A and 8B) is performed by one or more of the computing devices of the host portion 103. The method 800 modifies the start time and/or the end time of at least one of two or more overlapping infusions so that the infusions no longer overlap. The method 800 also calculates a non-overlapping or adjusted duration for any infusions with modified start and/or end times. Then, the host portion 103 advances to decision block 622.

In decision block 622, whether at least one infusion should be converted from an infusion to a push is determined. The decision in decision block 622 is “YES” when at least one infusion should be converted from an infusion to a push. On the other hand, the decision in decision block 622 is “NO” when none of the infusions should be converted from an infusion to a push.

When the decision in decision block 622 is “NO,” the host portion 103 advances to block 628.

When the decision in decision block 622 is “YES,” in block 626, any infusions identified in the decision block 622 as needing to be converted from infusions to pushes are converted to pushes. Then, the host portion 103 advances to decision block 628.

In block 628, a billing code and a number of billable units are assigned to each infusion that was not converted to a push. A set of rules (e.g., rules established by the CPT) may be used to determine the billing code and number of billable units. For example, according to the CPT, a repeat of an IV infusion of the same medication is not reported as a sequential new drug but is instead reported using an “add-on” code in the amount of one unit. In block 630, the billing code(s) and number(s) of billable units determined in block 628 are stored in the database computing device 160.

In decision block 635, whether the input included any pushes is determined. The decision in decision block 635 is “YES” when the input included at least one push or at least one infusion was converted to a push in block 626. On the other hand, the decision in decision block 635 is “NO” when the input did not include any pushes and none of the infusions was converted to pushes in block 626.

When the decision in decision block 635 is “NO,” the host portion 103 advances to decision block 655.

When the decision in decision block 635 is “YES,” in block 640, a billing code and a number of billable units are assigned to each push. A set of rules (e.g., rules established by the CPT) may be used to determine the billing code and a number of billable units. For example, the CPT rules specify a minimum time interval that must elapse between IV pushes of the same medication. In decision block 622, the host portion 103 verifies that the minimum time interval is met before assigning a billing code and number of billable units to a repeat administration of a medication. Optionally, the host portion 103 may instruct the data entry screen 300 to display a message or alert to the end user 112 that the minimum time interval has not elapsed, if appropriate.

In block 650, the billing code(s) and number(s) of billable units determined in block 640 are stored in the database computing device 160.

In decision block 655, whether the input included any hydration services is determined. The decision in decision block 655 is “YES” when the input included one or more hydration services. On the other hand, the decision in decision block 655 is “NO” when the input did not include any hydration services.

When the decision in decision block 655 is “NO,” the method 600 terminates.

When the decision in decision block 655 is “YES,” in decision block 657, whether the input included more than one hydration service is determined. The decision in decision block 657 is “YES” when the input included more than one hydration service. On the other hand, the decision in decision block 657 is “NO” when the input included only one or no hydration services.

When the decision in decision block 657 is “NO,” the host portion 103 advances to decision block 658.

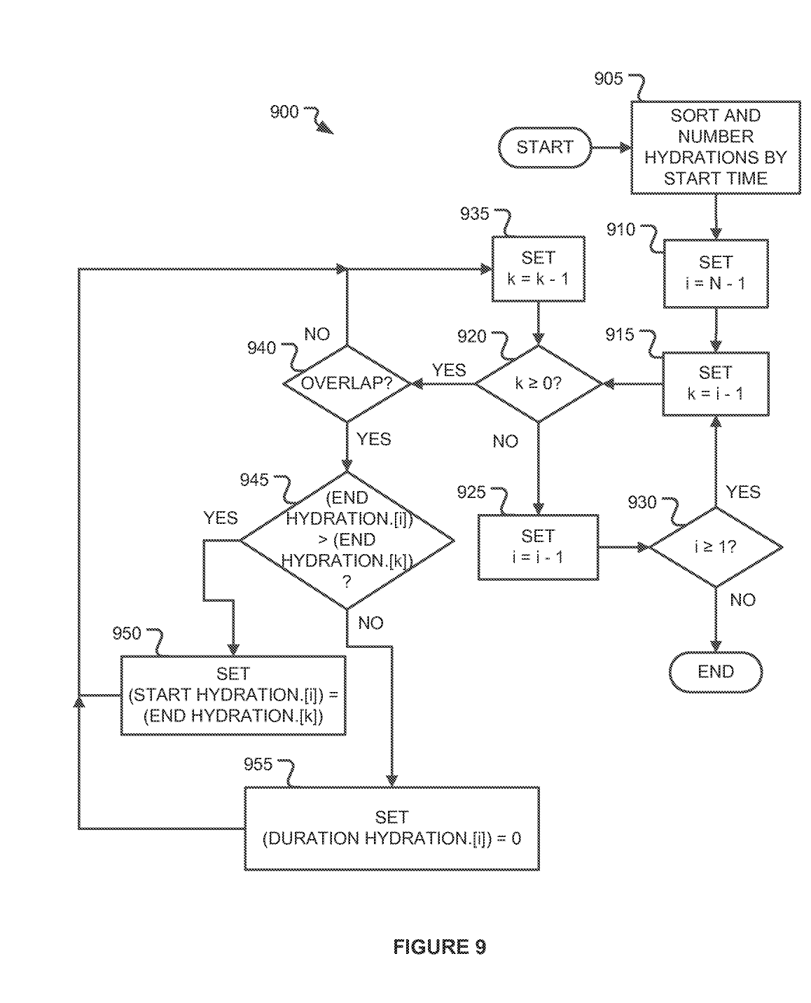

When the decision in decision block 657 is “YES,” in block 660, the host portion 103 performs a method 900 (see FIG. 9). The method 900 modifies the start time and/or the end time of at least one of two or more overlapping hydration services so the hydration services no longer overlap. Then, the host portion 103 advances to decision block 658.

In decision block 658, whether the input included any infusion services is determined. The decision in decision block 658 is “YES” when the input included one or more infusion services. On the other hand, the decision in decision block 658 is “NO” when the input did not include any infusion services. When the decision in decision block 658 is “NO,” the method 600 terminates.

When the decision in decision block 658 is “YES,” in block 665, a hydration service is selected.

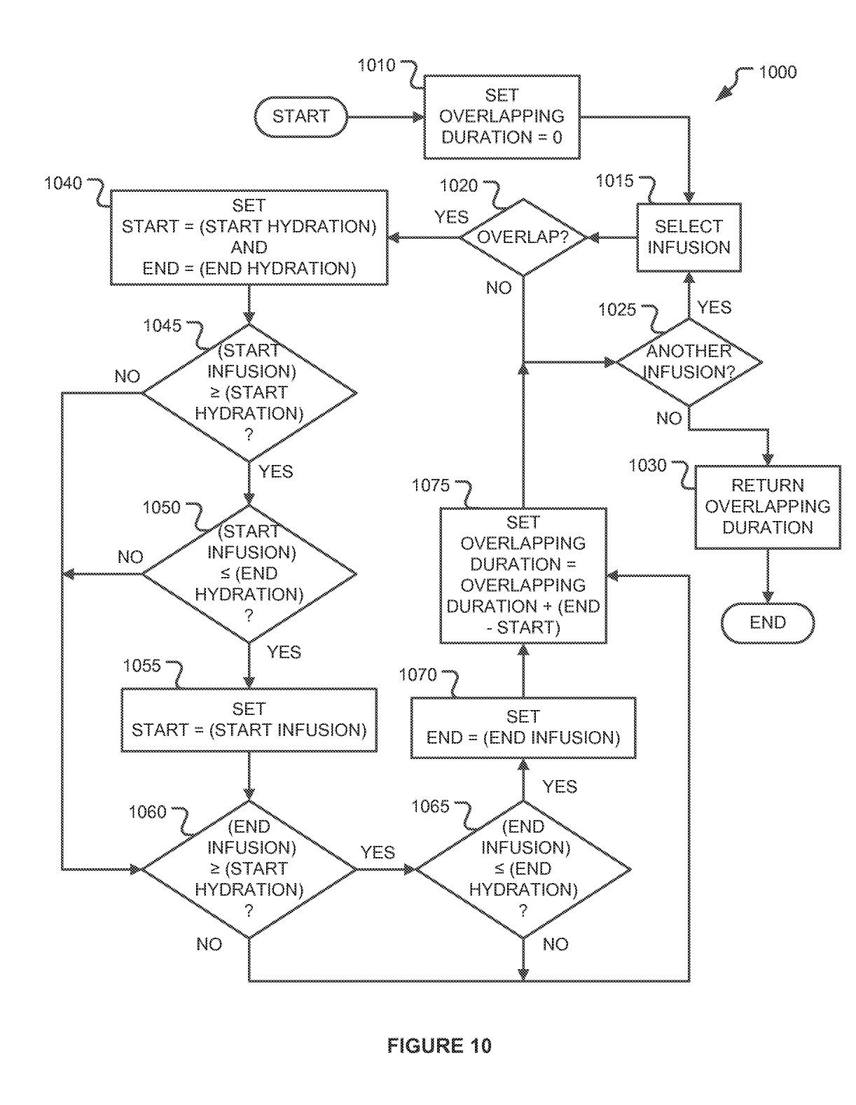

In block 670, the host portion 103 performs a method 1000 (see FIG. 10) for the selected hydration. The method 1000 determines whether the selected hydration service overlaps with any infusion services (which have priority over hydration services). The method 1000 also calculates a total overlap amount. In block 675, the total overlap amount is subtracted from the duration of the selected hydration service (which may have also been modified in the method 900).

In block 680, a billing code and a number of billable units is assigned to the selected hydration service. A set of rules (e.g., rules established by the CPT) may be used to determine the billing code and number of billable units.

In block 685, the billing code and number of billable units determined in block 680 are stored in the database computing device 160.

In decision block 690, whether another hydration service is included in the input that has not yet been selected in block 665 is determined. The decision in decision block 690 is “YES” when the input includes another hydration service that has not yet been selected in block 665. On the other hand, the decision in decision block 690 is “NO” when all of the hydration services in the input have been selected in block 665.

When the decision in decision block 690 is “NO,” the method 600 terminates.

When the decision in decision block 690 is “YES,” the host portion 103 returns to block 665 to select another hydration service.

### Method 800

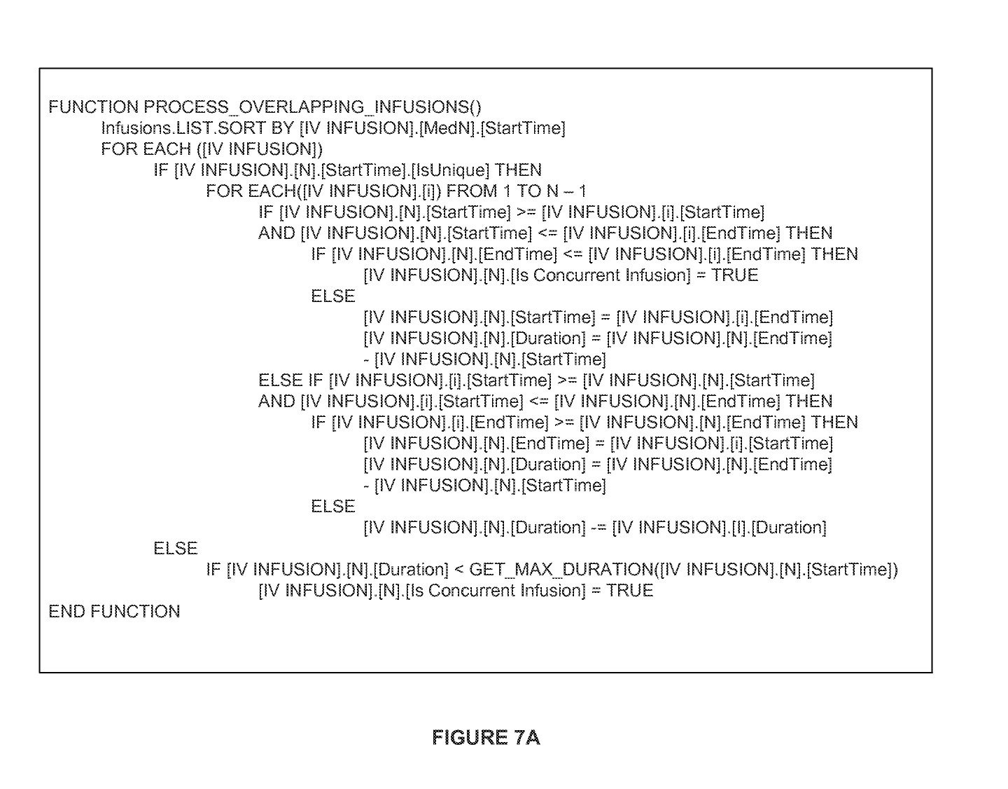

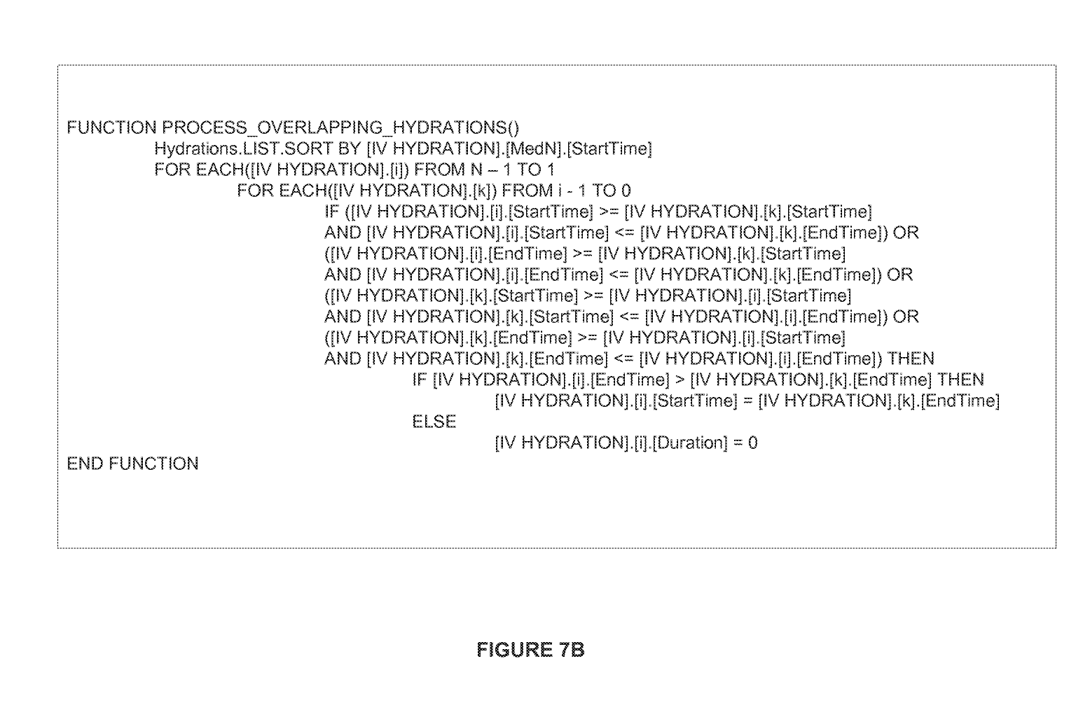

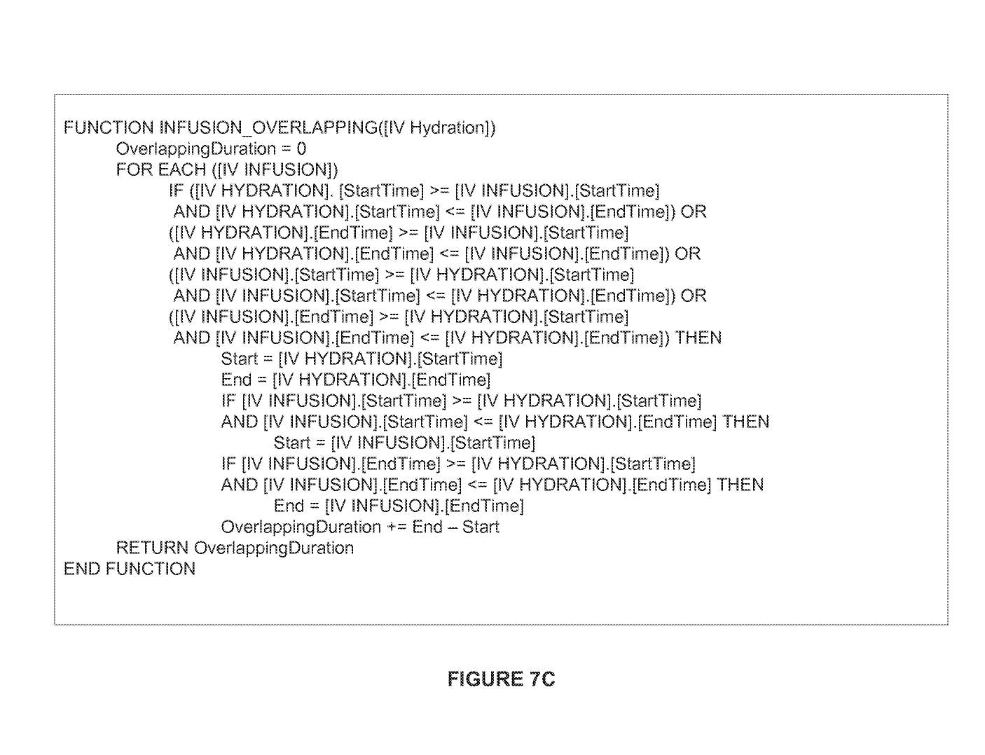

FIG. 7A provides a non-limiting example of pseudo source code for an exemplary function PROCESS_OVERLAPPING_INFUSIONS( ) that calculates the durations of IV medication infusion services, including those that overlap. The pseudo source code also modifies the start time and/or end time of at least one of two or more overlapping infusions so that the infusions no longer overlap. FIGS. 8A and 8B are a flow diagram of the method 800. The pseudo source code of FIG. 7A is an exemplary implementation of the method 800.

Turning to FIG. 8A, in first block 805, the infusions are sorted and numbered by start time (which includes a date component) to create a sorted list of infusions. The infusions in the list may be sorted from earliest start time to latest start time.

In block 810, a counter “N” is set equal to one. The counter “N” is used as an index to the sorted list of infusions.

In decision block 815, whether the infusion assigned a number equal to the value of the counter “N” has a unique start time is determined. The decision in decision block 815 is “YES” when the infusion assigned a number equal to the value of the counter “N” has a unique start time. On the other hand, the decision in decision block 815 is “NO” when the infusion assigned a number equal to the value of the counter “N” does not have a unique start time.

When the decision in decision block 815 is “NO,” the longest (or maximum) duration is determined for any infusions having a start time equal to the start time of the infusion assigned a number equal to the value of the counter “N.”Then, in decision block 830, whether the infusion assigned a number equal to the value of the counter “N” has a duration less than the maximum duration is determined. The decision in decision block 830 is “YES” when the infusion assigned a number equal to the value of the counter “N” has a duration less than the maximum duration. On the other hand, the decision in decision block 830 is “NO” when the infusion assigned a number equal to the value of the counter “N” has a duration equal to the maximum duration.

If two infusions start at the same time and end at the same time, one of the infusions is identified as being a “concurrent infusion.” A concurrent infusion is overlapped completely by another infusion. The duration of a concurrent infusion cannot be billed under CPT rules. Instead, only one billable unit may be billed for the concurrent infusion. Further, only one concurrent infusion may be billed regardless of how many concurrent infusions are performed.

When the decision in decision block 830 is “NO,” the host portion 103 advances to block 840.

When the decision in decision block 830 is “YES,” the infusion assigned a number equal to the value of the counter “N” is identified as being concurrent with another infusion. In other words, the infusion is identified as being a “concurrent infusion.” Then, the host portion 103 advances to block 840.

When the decision in decision block 815 is “YES,” in block 820, the value of a counter “i” is set equal to one. The counter “i” is also used as an index to the sorted list of infusions.

In decision block 825 whether the value of the counter “i” is less than or equal to the value of the counter “N” minus one is determined. The decision in decision block 825 is “YES” when the value of the counter “i” is less than or equal to the value of the counter “N” minus one. On the other hand, the decision in decision block 825 is “NO” when the value of the counter “i” is greater than the value of the counter “N” minus one.

When the decision in decision block 825 is “NO,” the host portion 103 advances to block 840.

When the decision in decision block 825 is “YES,” in decision block 855, whether the start time of the infusion assigned a number equal to the value of the counter “N” is greater than or equal to start time of the infusion assigned a number equal to the value of the counter “i” is determined. The decision in decision block 855 is “YES” when the start time of the infusion assigned a number equal to the value of the counter “N” is greater than or equal to start time of the infusion assigned a number equal to the value of the counter “i.” On the other hand, the decision in decision block 855 is “NO” when the start time of the infusion assigned a number equal to the value of the counter “N” is less than the start time of the infusion assigned a number equal to the value of the counter “i.”

When the decision in decision block 855 is “NO,” in decision block 865, whether the start time of the infusion assigned a number equal to the value of the counter “i” is greater than or equal to start time of the infusion assigned a number equal to the value of the counter “N” is determined. The decision in decision block 865 is “YES” when the start time of the infusion assigned a number equal to the value of the counter “i” is greater than or equal to start time of the infusion assigned a number equal to the value of the counter “N.” On the other hand, the decision in decision block 865 is “NO” when the start time of the infusion assigned a number equal to the value of the counter “i” is less than the start time of the infusion assigned a number equal to the value of the counter “N.”

When the decision in decision block 865 is “NO,” the host portion 103 advances to block 850.

When the decision in decision block 865 is “YES,” in decision block 880, whether the start time of the infusion assigned a number equal to the value of the counter “i” is less than or equal to end time of the infusion assigned a number equal to the value of the counter “N” is determined. The decision in decision block 880 is “YES” when the start time of the infusion assigned a number equal to the value of the counter “i” is less than or equal to end time of the infusion assigned a number equal to the value of the counter “N.” On the other hand, the decision in decision block 880 is “NO” when the start time of the infusion assigned a number equal to the value of the counter “i” is greater than the end time of the infusion assigned a number equal to the value of the counter “N.”

When the decision in decision block 880 is “NO,” the host portion 103 advances to block 850.

When the decision in decision block 880 is “YES,” in decision block 890, whether the end time of the infusion assigned a number equal to the value of the counter “i” is greater than or equal to end time of the infusion assigned a number equal to the value of the counter “N” is determined. The decision in decision block 890 is “YES” when the end time of the infusion assigned a number equal to the value of the counter “i” is greater than or equal to end time of the infusion assigned a number equal to the value of the counter “N.” On the other hand, the decision in decision block 890 is “NO” when the end time of the infusion assigned a number equal to the value of the counter “i” is less than the end time of the infusion assigned a number equal to the value of the counter “N.”

When the decision in decision block 890 is “NO,” in block 896, the duration of the infusion assigned a number equal to the value of the counter “i” is subtracted from the duration of the infusion assigned a number equal to the value of the counter “N.” The reason for this is that the infusion assigned a number equal to the value of the counter “i” is delivered entirely within the duration of the infusion assigned a number equal to the value of the counter “N.” In other words, the infusion assigned a number equal to the value of the counter “N” started before and ended after the infusion assigned a number equal to the value of the counter “i.” Then, the host portion 103 advances to block 850.

When the decision in decision block 890 is “YES,” in block 892, the end time of the infusion assigned a number equal to the value of the counter “N” is set equal to the start time of the infusion assigned a number equal to the value of the counter “i.” The duration of the infusion assigned a number equal to the value of the counter “N” is then calculated as its end time minus its start time. The reason for this is that the infusion assigned a number equal to the value of the counter “i” overlapped with the infusion assigned a number equal to the value of the counter “N” but the infusion assigned a number equal to the value of the counter “i” started after and ended after the infusion assigned a number equal to the value of the counter “N.” Then, the host portion 103 advances to block 850.

When the decision in decision block 855 is “YES,” in decision block 860, whether the start time of the infusion assigned a number equal to the value of the counter “N” is less than or equal to the end time of the infusion assigned a number equal to the value of the counter “i” is determined. The decision in decision block 860 is “YES” when the start time of the infusion assigned a number equal to the value of the counter “N” is less than or equal to the end time of the infusion assigned a number equal to the value of the counter “i.” On the other hand, the decision in decision block 860 is “NO” when the start time of the infusion assigned a number equal to the value of the counter “N” is greater than the end time of the infusion assigned a number equal to the value of the counter “i.”

When the decision in decision block 860 is “NO,” the host portion 103 advances to decision block 865.

When the decision in decision block 860 is “YES,” in decision block 870, whether the end time of the infusion assigned a number equal to the value of the counter “N” is less than or equal to the end time of the infusion assigned a number equal to the value of the counter “i” is determined. The decision in decision block 870 is “YES” when the end time of the infusion assigned a number equal to the value of the counter “N” is less than or equal to the end time of the infusion assigned a number equal to the value of the counter “i.” On the other hand, the decision in decision block 870 is “NO” when the end time of the infusion assigned a number equal to the value of the counter “N” is greater than the end time of the infusion assigned a number equal to the value of the counter “i.”

When the decision in decision block 870 is “NO,” in block 875, the start time of the infusion assigned a number equal to the value of the counter “N” is set equal to the end time of the infusion assigned a number equal to the value of the counter “i.” The duration of the infusion assigned a number equal to the value of the counter “N” is then calculated as its end time minus its start time. The reason for this is that the infusion assigned a number equal to the value of the counter “i” overlapped with the infusion assigned a number equal to the value of the counter “N” but the infusion assigned a number equal to the value of the counter “i” started before and ended before the infusion assigned a number equal to the value of the counter “N.” Then, the host portion 103 advances to block 850.

When the decision in decision block 870 is “YES,” in block 885, the infusion assigned a number equal to the value of the counter “N” is identified as being concurrent with the infusion assigned a number equal to the value of the counter “i.” In other words, the infusion assigned a number equal to the value of the counter “N” starts after and ends before the infusion assigned a number equal to the value of the counter “i.” Thus, the infusion assigned a number equal to the value of the counter “N” is identified as being a “concurrent infusion.” Then, the host portion 103 advances to block 850.

In block 850, the value of the counter “i” is incremented (increased by one). Then, the host portion 103 advances to decision block 825.

In block 840, the value of the counter “N” is incremented (increased by one).

Then, in decision block 845 whether the value of the counter “N” is less than or equal to the total number of infusions is determined. The decision in decision block 845 is “YES” when the value of the counter “N” is less than or equal to the total number of infusions. On the other hand, the decision in decision block 845 is “NO” when the value of the counter “N” is greater than the total number of infusions.

When the decision in decision block 845 is “YES,” the host portion 103 returns to decision block 815.

When the decision in decision block 845 is “NO,” the method 800 terminates.

### Method 900

FIG. 7B provides pseudo source code for an exemplary function PROCESS_OVERLAPPING_HYDRATIONS( ) that adjusts the start time and/or end time of at least one of two or more overlapping hydration services so that they no longer overlap. FIG. 9 is a flow diagram of the method 900. The pseudo source code of FIG. 7B is an exemplary implementation of the method 900.

Turning to FIG. 9, in first block 905, the hydrations are sorted and numbered by start time (which includes a date component) to create a sorted list of hydrations. The hydrations in the list may be sorted from earliest start time to latest start time. The value of a variable “N” is set equal to the number of hydrations.

In block 910, the value of a counter “i” is set equal to the value of the variable “N” minus one. The counter “i” is used as an index to the sorted list of hydrations.

In block 915, the value of a counter “k” is set equal to the value of the counter “i” minus one. The counter “k” is used as an index to the sorted list of hydrations.

Then, in decision block 920 whether the value of the counter “k” is greater than or equal to zero is determined. The decision in decision block 920 is “YES” when the value of the counter “k” is greater than or equal to zero. On the other hand, the decision in decision block 920 is “NO” when the value of the counter “k” is less than zero.

When the decision in decision block 920 is “NO,” in block 925, the value of the counter “i” is decreased by one. Then, in decision block 930, whether the value of the counter “i” is greater than or equal to one is determined. The decision in decision block 930 is “YES” when the value of the counter “i” is greater than or equal to one. On the other hand, the decision in decision block 930 is “NO” when the value of the counter “i” is less than one.

When the decision in decision block 930 is “YES,” the host portion 103 returns to block 915.

When the decision in decision block 930 is “NO,” the method 900 terminates.

When the decision in decision block 920 is “YES,” in decision block 940, whether the hydration assigned a number equal to the value of the counter “i” overlaps the hydration assigned a number equal to the value of the counter “k” is determined. The decision in decision block 940 is “YES” when the hydration assigned a number equal to the value of the counter “i” overlaps the hydration assigned a number equal to the value of the counter “k.” On the other hand, the decision in decision block 940 is “NO” when the hydration assigned a number equal to the value of the counter “i” does not overlap the hydration assigned a number equal to the value of the counter “k.”

When the decision in decision block 940 is “NO,” in block 935, the value of the counter “k” is reduced by one. Then, the host portion 103 returns to decision block 920.

When the decision in decision block 940 is “YES,” in decision block 945, whether the end time of the hydration assigned a number equal to the value of the counter “i” is greater than the end time of the hydration assigned a number equal to the value of the counter “k” is determined. The decision in decision block 945 is “YES” when the end time of the hydration assigned a number equal to the value of the counter “i” is greater than the end time of the hydration assigned a number equal to the value of the counter “k.” On the other hand, the decision in decision block 945 is “NO” when the end time of the hydration assigned a number equal to the value of the counter “i” is less than or equal to the end time of the hydration assigned a number equal to the value of the counter “k.”

When the decision in decision block 945 is “YES,” in block 950, the start time of the hydration assigned a number equal to the value of the counter “i” is set equal to the end time of the hydration assigned a number equal to the value of the counter “k.” Then, the host portion 103 advances to block 935.

When the decision in decision block 945 is “NO,” in block 955, the duration of the hydration assigned a number equal to the value of the counter “i” is set equal to zero. Then, the host portion 103 advances to block 935.

### Method 1000

FIG. 7C provides pseudo source code for an exemplary function INFUSION_OVERLAPPING([IV Hydration]) that adjusts the duration of a hydration service received as an input parameter if the hydration service overlaps with one or more infusion services. FIG. 10 is a flow diagram of the method 1000. The pseudo source code of FIG. 7C is an exemplary implementation of the method 1000. If the types of services include chemotherapy infusions, in the method 1000, chemotherapy infusion services and IV medication infusion services may both treated as infusions. Chemotherapy infusion services are given a higher priority (or rank) than IV medication infusion services. However, in some implementations, additional rules may control how multiple or overlapping chemotherapy infusions are billed.

Turning to FIG. 10, before the method 1000 begins, a hydration service has been selected (e.g., in block 665 of the method 600).

In first block 1010, the value of a variable “OverlappingDuration” is set equal to zero. Then, in block 1015, an infusion service is selected. In decision block 1020, whether the selected infusion overlaps with the selected hydration is determined. The decision in decision block 1020 is “YES” when the selected infusion overlaps with the selected hydration. On the other hand, the decision in decision block 1020 is “NO” when the selected infusion does not overlap with the selected hydration.

When the decision in decision block 1020 is “NO,” in decision block 1025, whether there is another infusion that has not yet been selected in block 1015 is determined. The decision in decision block 1025 is “YES” when there is another infusion that has not yet been selected in block 1015. On the other hand, the decision in decision block 1025 is “NO” when all of the infusions have been selected in block 1015.

When the decision in decision block 1025 is “YES,” the host portion 103 returns to block 1015 to select another infusion.

When the decision in decision block 1025 is “NO,” in block 1030, the value of the variable “OverlappingDuration” is returned. Then, the method 1000 terminates.

When the decision in decision block 1020 is “YES,” in block 1040, the value of a variable “start” is set equal to the start time of the selected hydration, and the value of a variable “end” is set equal to the end time of the selected hydration.

Then, in decision block 1045, whether the start time of the selected infusion is greater than or equal to the start time of the selected hydration is determined. The decision in decision block 1045 is “YES” when the start time of the selected infusion is greater than or equal to the start time of the selected hydration. On the other hand, the decision in decision block 1045 is “NO” when the start time of the selected infusion is less than the start time of the selected hydration.

When the decision in decision block 1045 is “NO,” the host portion 103 advances to decision block 1060.

When the decision in decision block 1045 is “YES,” in decision block 1050, whether the start time of the selected infusion is less than or equal to the end time of the selected hydration is determined. The decision in decision block 1050 is “YES” when the start time of the selected infusion is less than or equal to the end time of the selected hydration. On the other hand, the decision in decision block 1050 is “NO” when the start time of the selected infusion is greater than the end time of the selected hydration.

When the decision in decision block 1050 is “NO,” the host portion 103 advances to decision block 1060.

When the decision in decision block 1050 is “YES,” in block 1055, the value of the variable “start” is set equal to the start time of the selected infusion. Then, the host portion 103 advances to decision block 1060.

In decision block 1060, whether the end time of the selected infusion is greater than or equal to the start time of the selected hydration is determined. The decision in decision block 1060 is “YES” when the end time of the selected infusion is greater than or equal to the start time of the selected hydration. On the other hand, the decision in decision block 1060 is “NO” when the end time of the selected infusion is less than the start time of the selected hydration.

When the decision in decision block 1060 is “NO,” the host portion 103 advances to block 1075.

When the decision in decision block 1060 is “YES,” in decision block 1065, whether the end time of the selected infusion is less than or equal to the end time of the selected hydration is determined. The decision in decision block 1065 is “YES” when the end time of the selected infusion is less than or equal to the end time of the selected hydration. On the other hand, the decision in decision block 1065 is “NO” when the end time of the selected infusion is greater than the end time of the selected hydration.

When the decision in decision block 1065 is “YES,” in block 1070, the value of the variable “end” is set equal to the end time of the selected infusion. Then, the host portion 103 advances to decision block 1075.

When the decision in decision block 1065 is “NO,” the host portion 103 advances to block 1075.

In block 1075, the value of the variable “OverlappingDuration” is increased by the difference between the value of the variable “end” and the value of the variable “start.” Then, the host portion 103 advances to decision block 1025.

### Example

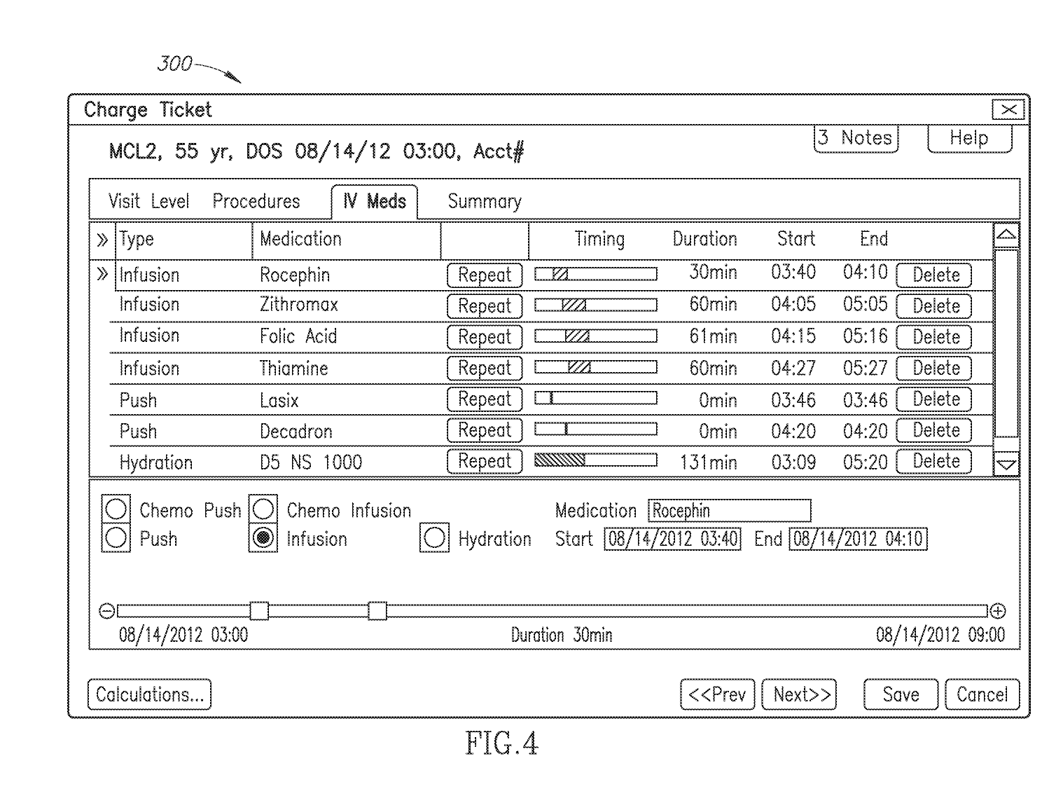

FIG. 4 depicts the data entry screen 300 populated with patient treatment information for an emergency department visit. During the visit, the patient received IV services that included four IV infusions, two IV pushes, and a hydration service. These services are summarized in Table 2 below:

TABLE 2

| Type | Medication | Duration | Start | End |
|---|---|---|---|---|
| Infusion | Rocephin | 30 min. | 3:40 | 4:10 |
| Infusion | Zithromax | 60 min | 4:05 | 5:05 |
| Infusion | Folic Acid | 61 min | 4:15 | 5:16 |
| Infusion | Thiamine | 60 min. | 4:27 | 5:27 |
| Push | Lasix | 0 min. | 3:46 | 3:46 |
| Push | Decadron | 0 min. | 4:20 | 4:20 |
| Hydration | D5 NS 1000 | 131 min | 3:09 | 5:20 |

FIG. 5 depicts the user interface summary screen 500 displaying the billing codes and numbers of billable units for the services in Table 2 determined using the method 600 (see FIG. 6). The summary screen 500 shows the billing code assigned to each service, a description of the service, a blank field for a hospital specific billing reference code (e.g., a code from the hospital's charge master), and the number of billable units to be billed. This information is summarized in Table 3 below:

TABLE 3

| | | | |
|---|---|---|---|
| | | Ref | |
| Code | Description | Code | Units |

| | | |
|---|---|---|
| 96361 | Hydration; each additional hour | x1 |
| 96365 | Intravenous infusion; initial, up to 90 min | x1 |
| 96367 | Intravenous infusion; additional sequential | x1 |
| | infusion, up to 90 min | |
| 96375 | Intravenous push, new drug, each additional | x4 |
| | sequential push | |

Thus, the services depicted in FIG. 4 and listed in Table 2 would be billed using the billing codes and numbers of billable units depicted in FIG. 5 and listed in Table 3. Specifically, the method 600 (see FIG. 6) indicated that the 131 minutes of hydration is to be billed (as an “add on”) as one unit (“x1”) of hydration using code 96361. While the hydration was provided for 131 minutes, less than an hour was provided without overlapping at least one of the other services. Hydration has the lowest ranking and is primary only when no other services are being provided. Therefore, the hydration was billed as an “add on” unit of service. As directed by the CPT coding instructions, the hydration service is billed as additional hours (or “add on” units) even though the hydration service was the earliest or first service actually provided. Because the method 600 (see FIG. 6) indicated that one unit of hydration may be billed, the amount of time exceeded the minimum amount of time, 30 minutes, indicated in the CPT and satisfied any other applicable billing rules.

Infusions and pushes occurred from 3:40 to 5:27 (or 107 minutes), with a total of six drugs delivered. The method 600 (see FIG. 6) indicated that one of the infusions (e.g., Rocephin) is to be billed as one unit (“x1”) of infusion using code 96365, the IV primary infusion service. Another infusion (e.g., Zithromax) qualified as new sequential IV infusions because this infusion was administered for 16 minutes or longer. The method 600 (see FIG. 6) indicated that this infusion (e.g., Zithromax) is to be billed as one (“add on”) unit (“x1”) of infusion using code 96367, the new drug sequential IV infusion code. The other two infusions (e.g., folic acid and Thiamine) did not qualify as infusions after the adjustment of their durations due to overlapping administration times. In other words, the duration of both of these infusions after adjustment was less than 16 minutes. Each non-qualifying infusion was automatically designated as an IV push of a sequential new drug. Thus, the method 600 (see FIG. 6) indicated that these infusions (e.g., folic acid and Thiamine) are each to be billed as one unit (“x1”) of intravenous push using code 96375 for a total of two units (“x2”). The two IV push medications (Lasix and Decadron) were also designated as sequential IV pushes using billing code 96375, which brings the total number of units of billing code 96375 to four units (“x4”).

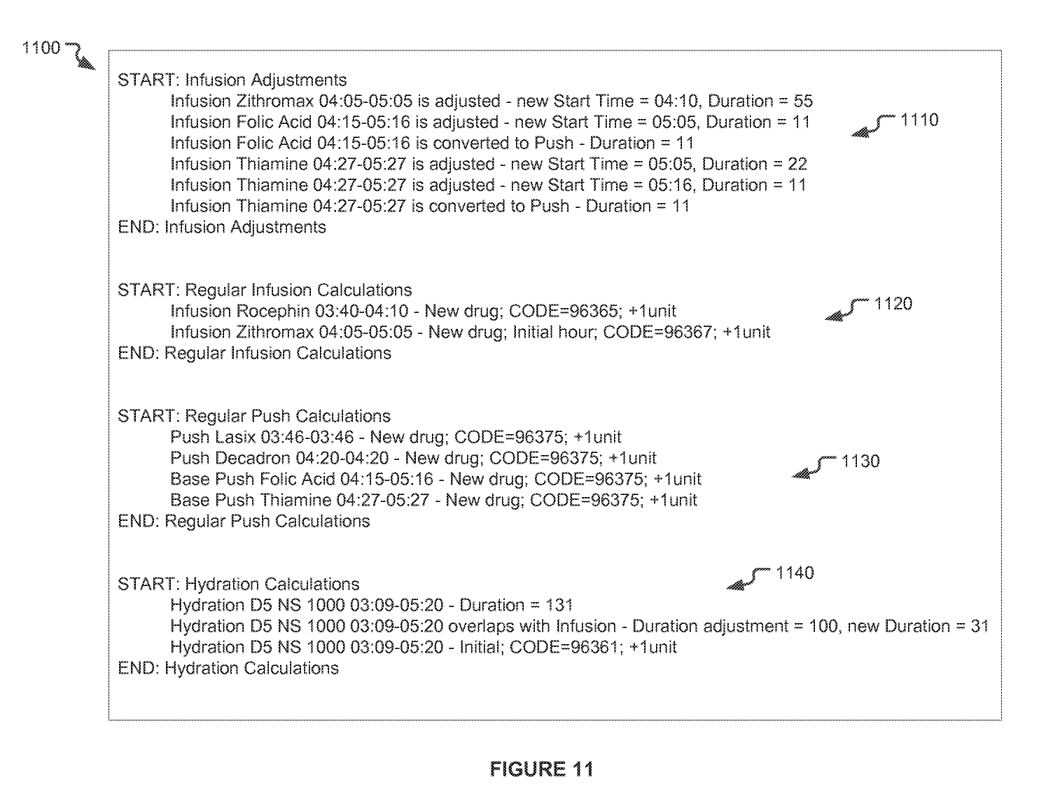

The end user 112 may use the summary screen 500 to view the adjustments made to the start time and/or end time of a time-based medical service and the business rule (e.g., a rule specified by the CPT) involved in the adjustment. Using the visualization feature, a coder (or any other individual wishing to validate the billed services) can see the adjustments made to each service and billing codes assigned by the method 600 (see FIG. 6). In some embodiments, this information may also be viewed in a listing of results 1100 (depicted in FIG. 11 and described below) that may be used as an audit trail.

### Audit Trail

For each encounter, the systems 100A and 100B may be configured to display the actual start time, adjusted start time, actual end time, and adjusted end time for each time-based medical service (e.g., using the screens 300 and 500 depicted in FIGS. 3A and 5). The screen 300 may also include the name of a service, name of a medication, duration of the service, adjustment of start time (if required, e.g., to satisfy a minimum interval requirement for repeat administrations), billing code, and the number of units of the service to be billed.

The systems 100A and 100B may also generate and print or display an audit trail. FIG. 11 is an exemplary listing of results 1100 generated by the method 600 of FIG. 6 that may be used as an audit trail. For ease of illustration, the results 1100 depicted are those generated for the exemplary patient treatment information of Table 2 above.

The results 1100 include an infusion adjustment portion 1110 that includes the results of the method 800 (see FIGS. 8A and 8B) and indicates which infusions have been converted to pushes. The results 1100 include a regular infusion calculations portion 1120 that includes the billing codes and numbers of billable units determined for each infusion. Optionally, the regular infusion calculations portion 1120 may identify any infusions that could not be billed (e.g., did not satisfy minimum duration requirements, were concurrent with another infusion, and the like).

The results 1100 include a regular push calculations portion 1130 that includes the billing codes and numbers of billable units determined for each push. Optionally, the regular push calculations portion 1130 may identify any pushes that could not be billed (e.g., did not satisfy minimum interval requirements).

The results 1100 include a hydration calculations portion 1140 that includes the results of the method 1000 (see FIG. 10) and the billing codes and numbers of billable units determined for each hydration service. Optionally, the hydration calculations portion 1140 may identify any hydrations that could not be billed.

Because the patient treatment information of Table 2 does not include multiple hydration services, the method 900 was not performed. However, if the patient treatment information includes more than one hydration service, the results 1100 may include a hydration adjustment portion (not shown) that includes the results of the method 900 (see FIG. 9).

The results 1100 provide the healthcare provider with a documented audit trail that details the adjustments and calculations made by the method 600 (see FIG. 6). Third parties (e.g., governmental entities, insurance companies, and the like) may use the results 1100 to confirm the validity of the services performed and the number of billable units (e.g., units of “add on” services) for which the third party is being billed.

While the “repeat” functionality of the systems 100A and 100B have been described with respect to time-based medical services, those of ordinary skill in the art appreciated that the systems may be used with non-time based medical services. For example, the “repeat” functionality may be used to determine billing codes and numbers of billing units for non-time based medical services. Further, the “repeat” functionality may be used to ensure that repeat administrations of a particular medication satisfy a predetermined minimum time interval between successive administrations. By way of a non-limiting example, the predetermined minimum time interval may be specified by the CPT.

### Computing Device

FIG. 12 is a diagram of hardware and an operating environment in conjunction with which implementations of the computing devices 110, 120, 130, 140A, 140B, 150, 152, 154, 160, 170, 172, and 190 of the systems 100A and 100B may be practiced. The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of the computing device 12. Each of the computing devices 110, 120, 130, 140A, 140B, 150, 152, 154, 160, 170, 172, and 190 of the systems 100A and 100B may be substantially identical to the computing device 12. By way of other non-limiting examples, the computing device 12 may be implemented as a laptop computer, a tablet computer, a web enabled television, a personal digital assistant, a game console, a smartphone, a mobile computing device, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including an operating system 35, one or more application programs 36, other program modules 37, and program data 38. A user may enter commands and information into the computing device 12 through input devices such as the keyboard 40 and a pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets and the Internet. The network portion 102 (see FIGS. 1A and 1B) of the systems 100A and 100B may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods 200 (illustrated in FIG. 2A), 230 (illustrated in FIG. 2B), 260 (illustrated in FIG. 2C), 600 (illustrated in FIG. 6), 800 (illustrated in FIGS. 8A and 8B), 900 (illustrated in FIG. 9), and 1000 (illustrated in FIG. 10) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A computer-implemented method performed by one or more computing devices, the method comprising:
receiving information associated with a plurality of time-based medical services, each of the plurality of time-based medical services being associated with a service type, a start time, and an end time, the information comprising the service type, the start time, and the end time associated with each of the plurality of time-based medical services;
identifying any of the plurality of time-based medical services associated with a same service type that overlapped;
modifying at least one of the start time and the end time of at least a portion of the identified time-based medical services so that the identified services no longer overlap;
calculating a duration for each of the plurality of time-based medical services, the duration being the difference between the end time and the start time of the time-based medical service;
if the plurality of medical services are associated with more than one service type, identifying a hierarchy that ranks the service types, identifying any of the plurality of time-based medical services having different service types that overlapped, and subtracting overlapping time from the duration of a lower ranked one of those of the plurality of time-based medical services associated with different service types that overlapped;
identifying one or more of the plurality of time-based medical services as billable based on a set of billing rules; and
identifying a billing code and a number of billable units for each of the plurality of time-based medical services identified as being billable.

2. The method of claim 1, wherein the set of billing rules comprises a predetermined time interval, each of a portion of the plurality of time-based medical services is associated with a medication, and the method further comprises:
identifying one or more repeat administrations of a particular medication within the plurality of time-based medical services, each repeat administration of the particular medication being administered in a same manner as a previous administration of the particular medication; and
identifying as billable each of the one or more repeat administrations that is separated from the previous administration of the particular medication by at least the predetermined time interval.

3. The method of claim 2, wherein an initial administration of the particular medication precedes the one or more repeat administrations of the particular medication, and
the billing code identified for each of the one or more repeat administrations of the particular medication identified as being billable is different from the billing code identified for the initial administration of the particular medication.

4. The method of claim 2, wherein the information received is first information, the predetermined time interval is a first predetermined time interval, the set of billing rules comprises a second predetermined time interval, the particular medication is a first medication, and the method further comprises:
receiving second information associated with a plurality of non-time-based medical services, each of a portion of the plurality of non-time-based medical services being associated with a medication;
identifying one or more repeat administrations of a second medication within the plurality of non-time-based medical services, each repeat administration of the second medication identified in the plurality of non-time-based medical services being administered in a same manner as a previous administration of the second medication identified in the plurality of non-time-based medical services; and
identifying as billable each of the one or more repeat administrations of the second medication that is separated from the previous administration of the second medication by at least the second predetermined time interval.

5. The method of claim 1, further comprising:
generating a graphical user interface depicting the start time and end time of each of the plurality of time-based medical services.

6. The method of claim 5, wherein the graphical user interface comprises a plurality of bars, each of the plurality of bars corresponding to a different one of the plurality of time-based medical services, each bar being sized to depict the duration of the corresponding time-based medical service, and positioned in accordance with the start time and the end time associated with the corresponding time-based medical service, such that the plurality of bars visually display any overlap that occurred in the plurality of time-based medical services.

7. The method of claim 1, wherein the duration is a modified duration and is calculated after the at least one of the start time and the end time of the portion of the identified time-based medical services is modified, and the method further comprises:
generating a display comprising the modified duration of each of the portion of the identified time-based medical services.

8. The method of claim 7, further comprising:
calculating an initial duration for each of the time-based medical services before the modification of the at least one of the start time and the end time of the portion of the identified time-based medical services, the initial duration being the difference between the end time and the start time of the time-based medical service; and
calculating an adjustment amount for each of the portion of the identified time-based medical services, the adjustment amount being the difference between the initial duration and the modified duration, the display further comprising the adjustment amount.

9. The method of claim 8, wherein the display further comprises a portion of the set of billing rules that were used to identify one or more of the plurality of time-based medical services as billable.

10. The method of claim 9, wherein the display is organized by service type.

11. The method of claim 1, wherein identifying the one or more of the plurality of time-based medical services as billable based on the set of billing rules comprises:
determining whether the duration of each of the plurality of time-based medical services exceeds a minimum billing duration threshold.

12. The method of claim 1, wherein identifying the one or more of the plurality of time-based medical services as billable based on the set of billing rules comprises:
for each pair of time-based medical services associated with the same service type that overlapped, determining one of the pair is not billable if the one of the pair started after and ended before the other of the pair.

13. The method of claim 1, wherein identifying the one or more of the plurality of time-based medical services as billable based on the set of billing rules comprises:
converting the service type associated with one or more of the plurality of time-based medical services to a different service type in accordance with the set of billing rules.

14. The method of claim 13, wherein the service type associated with the one or more of the plurality of time-based medical services that was converted was an infusion service type before the conversion and a push service type after the conversion.

15. The method of claim 1 for use with a client computing device operated by an end user, wherein the information is received from the client computing device, and the method further comprises:
transmitting the billing code and the number of billable units for each of the plurality of time-based medical services identified as being billable to the client computing device for display thereby to the end user.

16. The method of claim 15, further comprising:
transmitting user interface components to the client computing device, the user interface components requesting the information from the end user and displaying the billing code and the number of billable units for each of the plurality of time-based medical services identified as being billable to the end user.

17. The method of claim 1 for use with first and second external computing devices, wherein the information is received from the first external computing device, and the method further comprises:
receiving a request from the second external computing device for the billing code and the number of billable units for each of the plurality of time-based medical services identified as being billable; and
in response to receiving the request, transmitting the billing code and the number of billable units for each of the plurality of time-based medical services identified as being billable to the second external computing device.

18. The method of claim 1, wherein the set of billing rules comprises a Current Procedural Terminology Manual published by the American Medical Association.

19. A system for use with at least one healthcare computing device, and at least one management computing device, the at least one healthcare computing device being configured to transmit patient treatment information, the patient treatment information identifying a plurality of time-based medical services, for each time-based medical service the patient treatment information comprising a start time, an end time, and a service type, the system comprising:
at least one host computing device connected to the at least one healthcare computing device and the at least one management computing device by a network, the at least one host computing device being configured to receive the patient treatment information transmitted by the at least one healthcare computing device, determine a billing code and number of billable units for each of the plurality of time-based medical services identified in the patient treatment information, and transmit the billing code and number of billable units determined for each of the plurality of time-based medical services to the at least one management computing device.

20. One or more non-transitory computer readable media comprising data comprising a set of billing rules, the media further comprising instructions executable one or more processors that when executed cause the one or more processors to perform a method comprising:
receiving information associated with a plurality of time-based medical services, each of the plurality of time-based medical services being associated with a service type, a start time, and an end time, the information comprising the service type, the start time, and the end time associated with each of the plurality of time-based medical services;
identifying any of the plurality of time-based medical services associated with a same service type that overlapped;
modifying at least one of the start time and the end time of at least a portion of the identified time-based medical services so that the identified services no longer overlap;
calculating a duration for each of the plurality of time-based medical services, the duration being the difference between the end time and the start time of the time-based medical service;
if the plurality of time-based medical services are associated with more than one service type, identifying a hierarchy that ranks the service types, identifying any of the plurality of time-based medical services having different service types that overlapped, and subtracting overlapping time from the duration of a lower ranked one of those of the plurality of time-based medical services associated with different service types that overlapped;
identifying one or more of the plurality of time-based medical services as billable based on a set of billing rules; and
identifying a billing code and a number of billable units for each of the plurality of time-based medical services identified as being billable.
